(19) United States
(12) Patent Application Publication
(10) Pub. No.: US 2019/0069149 A1
(43) Pub. Date: Feb. 28, 2019

(54) METHOD FOR CONFIGURING ACTION OF EXTERNAL DEVICE AND ELECTRONIC DEVICE FOR SUPPORTING THE SAME

(71) Applicant: Samsung Electronics Co., Ltd., Suwon-si (KR)

(72) Inventors: Ki Heung PARK, Yongin-si (KR); In Yong KIM, Suwon-si (KR); Sung Kwon JUNG, Suwon-si (KR); Hyun Suk OH, Seoul (KR); John LEE, Seoul (KR); Jun Ho LEE, Suwon-si (KR); Jun Pyo HONG, Suwon-si (KR)

(21) Appl. No.: 16/038,772

(22) Filed: Jul. 18, 2018

(30) Foreign Application Priority Data
Aug. 23, 2017 (KR) 10-2017-0106945

(51) Int. Cl. H04W 4/70; H04W 84/18; G05B 15/02; G06F 3/01; G06F 3/16

(52) U.S. Cl. CPC H04W 4/70; H04W 84/18; G06F 3/16; G06F 3/017; G05B 15/02

(57) ABSTRACT

An electronic device is provided. The electronic device includes at least one communication circuit, at least one memory storing at least one instruction, and at least one processor operatively connected with the at least one communication circuit and the at least one memory. The at least one processor, when executing the at least one instruction, being configured to control to access a server device based on the communication circuit and a specified user account, control to receive a device list associated with at least one external device registered based on the user account from the server device, generate configuration information for controlling an action according to a time interval of the at least one external device, based on the device list and a user input, and control to transmit the configuration information to the server device.

### CROSS-REFERENCE TO RELATED APPLICATION(S)

This application is based on and claims priority under 35 U.S.C. § 119(a) of a Korean patent application number 10-2017-0106945, filed on Aug. 23, 2017, in the Korean Intellectual Property Office, the disclosure of which is incorporated by reference herein in its entirety.

### BACKGROUND

### 1. Field

The disclosure relates to configuring actions of an external device.

### 2. Description of Related Art

After being connected with an external device, an electronic device may control an action (or an operation) of the external device in response to a user input.

The above information is presented as background information only to assist with an understanding of the disclosure. No determination has been made, and no assertion is made, as to whether any of the above might be applicable as prior art with regard to the disclosure.

### SUMMARY

Thus, when it is desired to control an operation of an external device, an electronic device may be activated at a corresponding time and an input operation of the electronic device should be directly performed. Further, since a plurality of external devices are independently controlled, it is impossible to combine functions provided by the plurality of external devices depending on user convenience.

Aspects of the disclosure are to address at least the above-mentioned problems and/or disadvantages and to provide at least the advantages described below. Accordingly, an aspect of the disclosure is to provide a method for configuring an action of an external device to configure the action of the external device in more diverse ways and an electronic device for supporting the same.

Additional aspects will be set forth in part in the description which follows and, in part, will be apparent from the description, or may be learned by practice of the presented embodiments.

In accordance with an aspect of the disclosure, a server may be provided. The server may include at least one communication circuit, at least one memory storing at least one instruction and configuration information associated with a user account, the configuration information including a trigger condition of a first action, a delay time of the first action, and a duration of the first action and at least one processor configured to be operatively with the at least one communication circuit and the at least one memory. The at least one processor, when executing the at least one instruction, is configured to control to receive an event from a first external device associated with the user account, when the received event meets the trigger condition of the first action, control to transmit first action information to start the first action to a second external device associated with the user account the delay time of the first action elapses, and control to transmit second action information to end the first action to the second external device after the duration of the first action, from the time when the first action information is transmitted, elapses.

In accordance with an aspect of the disclosure, an electronic device is provided. The electronic device may include a communication circuit, at least one memory storing at least one instruction, and at least one processor operatively connected with the at least one communication circuit and the at least one memory. The at least one processor, when executing the at least one instruction, being configured to control to access a server device based on the communication circuit and a specified user account, control to receive a device list associated with at least one external device registered based on the user account from the server device, generate configuration information for controlling an action according to a time interval of the at least one external device, based on the device list and a user input, and control to transmit the configuration information to the server device.

Various embodiments of the disclosure may configure an action of each of a plurality of external devices connected to a hub, a server, or the like in various forms.

Various embodiments may verify an action state of each of external devices in real time or may verify the action state of each of the external devices in various forms when performing an action.

Various embodiments may more easily generate, correct, or delete at least one action information.

In addition, various effects directly or indirectly ascertained through the disclosure may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an example of a system environment associated with configuring an action of an external device according to various embodiments of the disclosure;

FIG. 2 is a block diagram illustrating an example of a configuration of a service device according to various embodiments of the disclosure;

FIG. 3 is a signal sequence diagram illustrating an example of signal flow associated with generating configuration information in a system environment according to various embodiments of the disclosure;

FIG. 4 is a flowchart illustrating an example of an operation method of an electronic device associated with generating configuration information in a system environment according to various embodiments of the disclosure;

FIG. 5 is a signal sequence diagram illustrating an example of signal flow associated with performing an action of each of a plurality of external devices according to various embodiments of the disclosure;

FIG. 6 is a flowchart illustrating an example of an operation method of a server device associated with performing an action of each of a plurality of external devices according to various embodiments of the disclosure;

FIG. 7 is a signal sequence diagram illustrating an example of signal flow associated with a noti output according to performing an action of an external device, according to various embodiments of the disclosure;

FIG. 8 is a drawing illustrating an example of a screen including configuration information according to various embodiments of the disclosure;

FIG. 9 is a drawing illustrating an example of another configuration information according to various embodiments of the disclosure;

FIG. 10 is a drawing illustrating an example of a screen interface associated with configuring a time interval of an action according to various embodiments of the disclosure;

FIG. 11 is a drawing illustrating an example of a screen interface associated with generating configuration information according to various embodiments of the disclosure;

FIG. 12 is a drawing illustrating an example of a screen interface associated with correcting a time interval according to various embodiments of the disclosure;

FIG. 13 is a drawing illustrating an example of a screen interface associated with configuring a complex action of external devices according to various embodiments of the disclosure;

FIG. 14 is a drawing illustrating another example of a screen interface associated with configuring a complex action of external devices according to various embodiments of the disclosure;

FIG. 15 is a drawing illustrating an example of a screen interface associated with a noti output according to performing an action of an external device, according to various embodiments of the disclosure; and

FIG. 16 is a block diagram illustrating an electronic device 1601 in a network environment 1600 according to various embodiments of the disclosure.

Throughout the drawings, like reference numerals will be understood to refer to like parts, components, and structures.

### DETAILED DESCRIPTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms, such as “first,” “second,” and the like used herein may refer to various elements of various embodiments, but do not limit the elements. Furthermore, such terms may be used to distinguish one element from another element. For example, “a first user device” and “a second user device” may indicate different user devices regardless of the order or priority thereof. For example, “a first user device” and “a second user device” indicate different user devices.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there is no intervening element (e.g., a third element).

According to the situation, the expression “configured to” used herein may be used as, for example, the expression “suitable for,” “having the capacity to,” “designed to,” “adapted to,” “made to,” or “capable of”. The term “configured to” must not mean only “specifically designed to” in hardware. Instead, the expression “a device configured to” may mean that the device is “capable of” operating together with another device or other components, central processing unit (CPU), for example, a “processor configured to perform A, B, and C” may mean a dedicated processor (e.g., an embedded processor) for performing a corresponding operation or a generic-purpose processor (e.g., a CPU or an application processor) which may perform corresponding operations by executing one or more software programs which are stored in a memory device.

Terms used in the disclosure are used to describe specified embodiments and are not intended to limit the scope of the disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the disclosure. In some cases, even if terms are terms which are defined in the specification, they may not be interpreted to exclude embodiments of the disclosure.

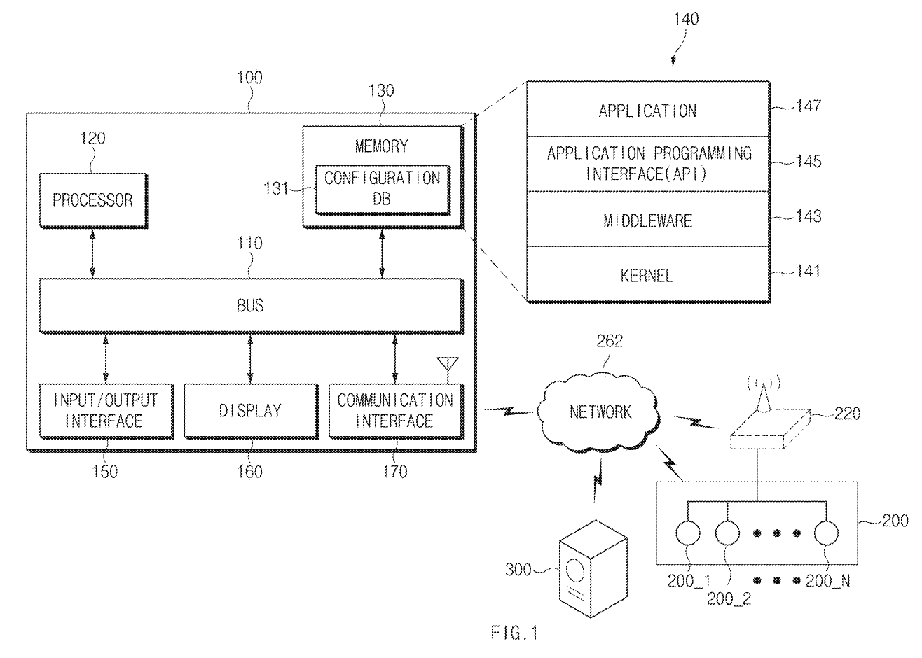

FIG. 1 is a block diagram illustrating an example of a system environment associated with configuring an action of an external device according to an embodiment of the disclosure.

Referring to FIG. 1, the system environment may include an electronic device (e.g., a mobile device or a portable terminal), a network 262, an external device (e.g., at least one Internet of things (IoT) or at least one external electronic device), and a server device 300 (e.g., a server device, a cloud server device, or the like for controlling the external device 200). Additionally or alternatively, the system environment may include a management device 220.

In the above-mentioned environment, the server device 300 may be connected with the external device 200 by wire or wireless. The server device 300 may process registration of the external device 200 through a user account. In this regard, a user may connect the external device 200 having a communication function to the server device 300 and may register the external device 200 with the server device 300 based on a registration procedure (e.g., record and manage at least one of identification information, connection information, or action information of the external device 200 in the server device 300 such that the server 300 recognizes the external device 200 having a specific action (or function) and transmits a message associated with an operation). In the registration process, the external device 200 may be registered through the user account stored in the server device 300.

The server device 300 may store and manage a device list of external devices included in the external device 200 registered through the user account and a configuration list associated with performing an action (or an operation or a function) of each of the external devices included in the external device 200. The server device 300 may provide at least a portion of the device list and the configuration list to the electronic device 100 in response to a request of the electronic device 100. According to various embodiments, at least some of the external devices included in the external device 200 may be connected to the management device 220, and the management device 220 may be connected to the server device 300 over a network 262. In this case, the at least some of the external devices included in the external device 200 may be controlled by the server device 300 via the management device 220.

The network 262 may support to establish, for example, a communication channel between the electronic device 100 and the server device 300 or a communication channel between the server device 300 and the external device 200. Alternatively, the network 262 may establish a communication channel between the management device 220 and the server device 300 or a communication channel between the external device 200 and the management device 220. The network 262 may include, for example, at least one device element capable of supporting a wireless communication function (e.g., various types of wireless communication schemes such as 2 generation (2G), 3G, 4G, long term evolution (LTE), and 5G), a wireless access communication function (e.g., a Wi-Fi communication function), or the like. For example, the network 262 may include a telecommunications network, for example, at least one of a computer network (e.g., a local area network (LAN) or a wide area network (WAN)), the Internet, or a telephone network. Alternatively, the network 262 may include a short-range communication network.

According to an embodiment, the network 262 may include a cellular communication network established between the electronic device 100 and the server device 300, a short-range communication network established between the server device 300 and the external device 200, an IoT communication network having a relatively limited bandwidth compared with the cellular communication network, or a short-range communication network with a short transmission range. According to various embodiments, the network 262 may include a wired and wireless network between the server device 300 and the management device 220 or a wired and wireless network between the management device 220 and the external device 200. As described above, the network 262 may include a network of one single communication scheme, a network of a plurality of different communication schemes, or the like.

The management device 220 may include at least one of, for example, a hub device or a server device. The management device 220 may be connected with at least a portion of at least one external device 200_1 to 200_N included in the external device 200. The management device 220 may process a command associated with controlling an action of the at least one external device 200_1 to 200_N included in the external device 200. The above-mentioned management device 220 may be integrated with the server device 300. Alternatively, the management device 220 may have at least some of functions of the server device 300, described below, and may be separated from the server device 200 in hardware to control an action of the external device 200 while communicating with the server device 300. When the management device 220 is implemented in the form of being separated from the server device 300, it may collect information about a device associated with the at least one external device 200_1 to 200_N connected with the management device 220 (e.g., a device name, a type of a function of the device, a state where the function of the device is executed, or the like). The management device 220 may directly provide the collected device information to at least one of the server device 300 and the electronic device 100 or may provide the collected device information to the electronic device 100 via the server device 300. The management device 220 may receive information about an action associated with controlling an operation of at least a portion of the at least one external device 200_1 to 200_N from the server device 300 or the electronic device 100. The management device 220 may control an operation of at least a portion of the at least one external device 200_1 to 200_N.

The external device 200 may include the at least one external device 200_1 to 200_N. The at least one external device 200_1 to 200_N may be, for example, an IoT device and may include at least one external electronic device capable of establishing a communication channel with a peripheral device (e.g., the electronic device 100, the server device 300, or the management device 220). For example, the at least one external device 200_1 to 200_N may include various electronic devices, for example, a lighting device, a temperature controller (e.g., a boiler device, an air conditioner, a heater, or the like), a multi-purpose sensor, a position sensor, a specific liquid or gas sensor, a contact sensor, a motion sensor, an alarm device, an information display device, a door device, and a home appliance (e.g., a television (TV), a refrigerator, a washing machine, or the like). The at least one external device 200_1 to 200_N according to various embodiments may include a fixed device (e.g., a device which is fixed to a specified location, such as a wall or ceiling or a window or the ground and is not moved before being unfixed).

The at least one external device 200_1 to 200_N may be grouped for, example, each predetermined location. For example, at least a portion of the at least one external device 200_1 to 200_N may be located a home area and may be operated by being grouped for each room or sector of a home. Alternatively, the at least one external device 200_1 to 200_N may be located by being divided into an office and a home. Thus, the at least one external device 200_1 to 200_N may be operated by being divided into an operation group for each office and an operation group for each home. The above-mentioned at least one external device 200_1 to 200_N may access the server device 300 or the management device 220 and may perform a specified operation based on a command corresponding to action information provided from the server device 300 or the management device 220.

According to various embodiments, the at least one external device 200_1 to 200_N may perform another action for each predetermined time depending on information about a time interval associated with performing (or triggering) an action. Alternatively, the at least one external device 200_1 to 200_N may execute a specified action depending on an action state of another external device or an action change state of the other external device. For example, a boiler device corresponding to an external device may supply hot water during a specified time interval depending on action information provided from the server device 300 or the management device 220 (hereinafter described on the basis of the server device 300). Alternatively, when a door device corresponding to an external device is opened in response to control of the server device 300, a power supply corresponding to another external device may be triggered by the open state of the door device to perform an action, for example, be powered on. Alternatively, triggered as the power supply is powered off, a boiler corresponding to another external device may perform a specific action, for example, supply hot water.

The electronic device 100 may establish a communication channel with the server device 300 over the network 262. The electronic device 100 may support to configure a condition and an action associated with controlling an action of the external device 200, based on at least a portion of a device list and a configuration list which are provided from the server device 300. According to an embodiment, the electronic device 100 may provide a screen interface for configuring at least one action of the external device 200 depending on a time interval (or at intervals of a predetermined time or for each set time). For example, the electronic device 100 may provide a screen interface including at least one of an item associated with setting a start time and an end time of at least one action of the external device 200 or an item associated with setting at least one of a start delay or an end delay of the at least one action of the external device 200. According to various embodiments, the electronic device 100 may provide a screen interface for outputting at least one of an arrival of a time when an action of the external device 200 will be performed or a response (or result) according to the performance of the action or designating an external device to output the arrival of the time when the action will be performed or the response according to the performance of the action.

The action may include at least one function performed by the external device 200. In connection with performing an action of the external device 200, the server device 300 may transmit at least one action information to the external device 200 depending on a condition. The action information may include a command to instruct to perform a specific operation of an external device. For example, the action information may include at least one control command associated with turning on or off a specific external device or adjusting a volume or brightness level. According to various embodiments, the electronic device 100 may provide a screen interface for providing an object or item associated with configuring the above-mentioned action information and a screen interface for combining a plurality of configuration information (including condition information associated with a condition of an action and action information) or correcting or deleting at least one configuration information. The electronic device 100 may more intuitively and easily generate, correct, or delete configuration information associated with controlling the external device 200 through the above-mentioned screen interface.

The electronic device 100 may include a bus 110, a processor 120, at least one memory 130 (or at least one storage device), an input/output interface 150, a display 160, and a communication interface 170 (or a communication circuit).

The bus 110 may interconnect, for example, the elements 120 to 170 and may include a circuit for delivering communication (e.g., a control message and/or data) between the elements 120 to 170. The bus 110 may deliver data corresponding to a configuration information screen to the display 160 and may deliver a user input associated with inputting configuration information to the processor 120.

The processor 120 may include one or more of a CPU, an application processor (AP), or a communication processor (CP). The processor 120 may execute, for example, an arithmetic operation or data processing about control and/or communication of at least one other element(s) of the electronic device 100.

According to an embodiment, the processor 120 may output a screen interface associated with configuring an action of at least a portion of the at least one external device 200_1 to 200_N connected to the server device 300 on the display 160 depending on a user input. For example, the processor 120 may output a screen interface for inputting configuration information of at least a portion of the at least one external device 200_1 to 200_N on the display 160. For example, the processor 120 may output a screen interface for designating a type of the at least one external device 200_1 to 200_N, a trigger condition of the at least one external device 200_1 to 200_N (e.g., a condition for allowing the at least one external device 200_1 to 200_N to start a specific action and a situation condition or a time condition), an action type, or the like.

According to various embodiments, the processor 120 may output a screen interface for configuring an action of at least a portion of the at least one external device 200_1 to 200_N to be performed within a predetermined time interval. As described above, the screen interface associated with configuring the time interval may include at least one of a period item (or a period operation duration item) for setting a start and end time of an action, an execution delay item for executing the action after a time corresponding to information which is input on the basis of a specified time, or an end delay item for ending the action after or before the time corresponding to the information which is input on the basis of the specified time.

According to various embodiments, the processor 120 may output a notification information configuration screen to be output in response to an event (or an event message) which occurs in connection with the at least one external device 200_1 to 200_N and a response according to performing an action of the at least one external device 200_1 to 200_N on the display 160. The notification information may be output through at least one of, for example, a text or an audio. The notification information may be output through, for example, the electronic device 100 or the at least one specified external device 200_1 to 200_N. In this regard, the processor 120 may provide a selection screen for selecting an external device to output the notification information.

The memory 130 may include a volatile and/or nonvolatile memory. The memory 130 may store, for example, instructions or data associated with at least one other element(s) of the electronic device 100. The instructions may be executed by the processor 120. According to an embodiment, the instructions may include an instruction set associated with executing an application associated with inputting configuration information, an instruction set associated with access of the server device 300 associated with controlling the at least one external device 200_1 to 200_N and outputting a configuration information input screen provided from the server device 300, an instruction set associated with transmitting generated configuration information to the server device 300, or the like.

According to various embodiments, the memory 130 may store a configuration database (DB) 131. The configuration DB 131 may include, for example, information of a device list of the at least one external device 200_1 to 200_N and information about at least one configuration list associated with controlling the at least one external device 200_1 to 200_N. The configuration DB 131 may be synchronized with a device list and a configuration list stored in the server device 300. In this regard, when the electronic device 100 accesses the server device 300, when a specified period arrives, or when an application associated with inputting configuration information is executed, the processor 120 may perform a synchronization task of the configuration DB 131 with the device list and the configuration list of the server device 300.

According to various embodiments, the memory 130 may store software and/or a program 140. The program 140 may include, for example, a kernel 141, a middleware 143, an application programming interface (API) 145, an application program (or “application”) 147, and/or the like. At least a portion of the kernel 141, the middleware 143, or the API 145 may be referred to as an “operating system (OS)”.

The application 147 may include a music application, an exercise (or healthcare) application, an alarm application, or the like. According to an embodiment, the application 147 may include a function of configuring condition information associated with controlling an action of the at least one external device 200_1 to 200_N or a function of configuring action information.

The input/output interface 150 may play a role as, for example, an interface capable of transmitting a command or data, input from a user or another external device, to other element(s) of the electronic device 100. Furthermore, the input/output interface 150 may output a command or data, received from other element(s) of the electronic device 100, to the user or the other external device. The input/output interface 150 may include, for example, at least one physical button, at least one touch button, a touch pad, a touch screen, or the like. Further, the input/output interface 150 may include an input means such as an electronic pen. Further, the input/output interface 150 may include an audio device for processing an audio signal. The audio device may output an audio notification depending on settings when outputting the above-mentioned notification information. An audio data output function may be omitted according to settings or a user input.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, a variety of content (e.g., a text, an image, a video, an icon, a symbol, or the like) to the user. The display 160 may include a touch screen and may receive, for example, a touch, gesture, proximity, or a hovering input using an electronic pen or a portion of a user's body.

The display 160 may output at least one screen according to access of the electronic device 100 to the server device 300 or a screen according to execution of an application associated with inputting configuration information of the at least one external device 200_1 to 200_N. Alternatively, the display 160 may output a notification output configuration screen of the at least one external device 200_1 to 200_N. When an event (or an event message) associated with the at least one external device 200_1 to 200_N or the result of performing an action (or a response) is received, the display 160 may output a screen according to the event or the result of performing the action.

The communication interface 170 may establish communication between, for example, the electronic device 100 and the management device 220. For example, the communication interface 170 may be connected to the network 262 over wireless communication to communicate with the server device 300, the external device 200 or the management device 220. According to an embodiment, the communication interface 170 may receive information about the external device 200 from the server device 300 or the management device 220. Further, the communication interface 170 may transmit configuration information for controlling an operation of the at least one external device 200_1 to 200_N to the server device 300.

The wireless communication may use at least one of, for example, LTE, LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like, as a cellular communication protocol. Furthermore, the wireless communication may include, for example, local wireless communication. The local wireless communication may include at least one of, for example, Wi-Fi, Bluetooth, near field communication (NFC), magnetic stripe transmission (MST), a global navigation satellite system (GNSS), or the like.

The GNSS may include at least one of, for example, a global positioning system (GPS), a global navigation satellite system (Glonass), a Beidou navigation satellite system (hereinafter referred to as “Beidou”), or a European global satellite-based navigation system (hereinafter referred to as “Galileo”) based on an available region, a bandwidth, or the like. Hereinafter, in this disclosure, “GPS” and “GNSS” may be interchangeably used. A wired communication interface may include at least one of, for example, a universal serial bus (USB), a high definition multimedia interface (HDMI), a recommended standard-232 (RS-232), a plain old telephone service (POTS), or the like.

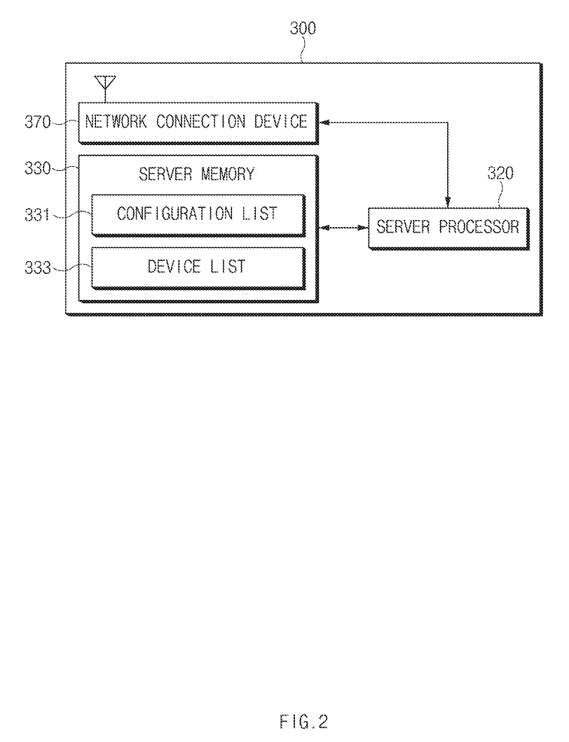

FIG. 2 is a block diagram illustrating an example of a configuration of a service device according to an embodiment.

Referring to FIG. 2, a server device 300 according to an embodiment may include a network connection device 370, at least one server memory 330 (or at least one storage device), and a server processor 320.

The network connection device 370 may include a communication circuit capable of establishing a communication channel with an electronic device 100 of FIG. 1 over a network 262 of FIG. 1 or a communication circuit capable of establishing a communication channel with an external device 200 of FIG. 1 over the network 262. Alternatively, when a management device 220 of FIG. 1 is implemented in the form of being separated from the server device 300, the network connection device 370 may include a communication circuit capable of establishing a communication channel with the management device 220.

The server memory 330 may store at least one application or instructions associated with operating the server device 300. According to an embodiment, the at least one application or the instructions may be implemented using a plurality of programming languages (e.g., JAVA, C, Golang, or the like). The server memory 330 may include at least one instruction set for operating a time interval in connection with processing configuration information. For example, the server memory 330 may include an instruction set configured to transmit action information to be transmitted to a specified external device to the external device during a duration determined in configuration information (or when the duration is started or when the duration expires), an instruction set configured to transmit action information to be transmitted to the specified external device, after a delay time determined in the configuration information.

According to an embodiment, the server memory 330 may store at least one user account. The at least one user account may be associated with the electronic device 100 or at least one external device 200_1 to 200_N of FIG. 1. According to various embodiments, the server memory 330 may include a device list 333 and a configuration list 331. The device list 333 may include device information of the at least one external device 200_1 to 200_N. The device information of such at least one external device 200_1 to 200_N may be registered through a specified user account or may be updated when device information of new external devices is obtained or when device information of registered external devices is removed. The configuration list 331 may include condition information where an action of the at least one external device 200_1 to 200_N will be performed or action information. The configuration list 331 may be updated when condition information or action information is changed, corrected, or deleted through a configuration information screen. The device list 333 and the configuration list 331 may be provided to the electronic device 100 associated with a user account, the at least one external device 200_1 to 200_N, the management device 220, or the like.

The server processor 320 may register or unregister the at least one external device 200_1 to 200_N. When the at least one external device 200_1 to 200_N associated with a specified user account is registered or unregistered, the server processor 320 may update a device list associated with the user account in the device list 333 stored in the server memory 330. In connection with registration, the server memory 330 may store a user account. In this regard, a user may access the server device 300 using the electronic device 100 or the like and may generate a user account in the server device 300. The user account may be associated with device information and configuration information of the at least one external device 200_1 to 200_N.

When the electronic device 100 (or the at least one external device 200_1 to 200_N or the management device 220, hereinafter described on the basis of the electronic device 100) accesses the server device 300, the server processor 320 may support to access the server device 300 based on a user account and may provide a page including a device list and a configuration list linked to the user account to the electronic device 100. The server processor 320 may receive configuration information of the at least one external device 200_1 to 200_N associated with a user account of the electronic device 100 from the electronic device 100.

The server processor 320 may support to update configuration information of the at least one external device 200_1 to 200_N. In this regard, the server processor 320 may generate a server page associated with generating, correcting (or changing), or deleting (or partially deleting) configuration information (e.g., a virtual screen interface output on a display) and may provide the server page to the electronic device 100 which accesses the server device 300. The server page may include at least one of, for example, a page for configuring an action of the at least one external device 200_1 to 200_N to be performed in response to a specified time interval, a page for combining configuration information of at least a portion of the at least one external device 200_1 to 200_N or separating the combined configuration information, a page for setting to perform an action according to a state of at least a portion of the at least one external device 200_1 to 200_N, a page for setting to output notification information indicating at least one of whether a time for performing an action arrives and the result of performing the action (or a response), or a page configured to share configuration information with another electronic device depending on a location. Alternatively, the server processor 320 may output a page including at least one of an item for setting a time interval of the above-mentioned action, an item for combining or separating configuration information, an item for setting to perform an action according to a state, an item for setting to output notification information, or item for sharing configuration information.

According to various embodiments, the server processor 320 may provide a server page for sharing the right to operate at least one external device which is operated for each location. The user (e.g., a portable terminal) may generate configuration information of at least one external device 200_1 to 200_N and may register another electronic device with a specified user account based on the server page such that the other electronic device may use the generated configuration information. The user who generates the configuration information may have the right to delete the configuration information. Another electronic device added by a sharing function may have the limited right to delete the configuration information.

According to various embodiments, in connection with operating configuration information, the server processor 320 may verify the stored configuration list 331 in real time, depending on a specified period, or in response to a user input (or a request of a portable terminal). The server processor 320 may extract action information associated with controlling an action of an external device which belongs to at least one user account depending on a specified condition from the configuration list 331 and may transmit the extracted action information to the external device. In this operation, the server processor 320 may transmit the action information to an external device directly connected to the server device 300. Alternatively, the server processor 320 may transmit the action information to an external device via the management device 220 connected with the external device.

According to various embodiments, in a process of transmitting action information to a specified external device, the action information may be transmitted after a predetermined delay time or during a predetermined duration (or when the duration is started or when the duration expires). In this case, the server processor 320 may use a command associated with managing the duration or the delay time to minimize resource allocation of the server device 300 during the delay time or the duration. For example, the server processor 320 may use a command, relatively small resources of which are allocated, during the delay time or the duration. In this regard, the server memory 330 may store a command, relatively small resources of which are allocated, when configuring a command associated with processing the delay time or the duration. The command, relatively small resources of which are allocated, may include a command, bits or bytes of which are relatively small, a command including a relatively small function, or the like.

After transmitting action information, the server processor 320 may receive a response according to performing an action from an external device which receives the transmitted action information. The server processor 320 may update the configuration list 331 based on the received response or may transmit the received response to at least one of a specified external device (e.g., at least one of an audio device, a video device, an audio/video device) or the electronic device 100.

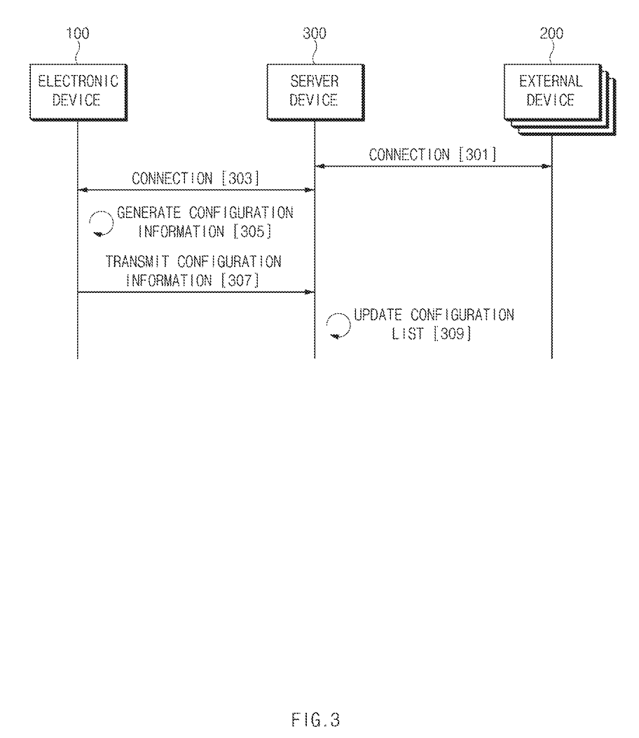

FIG. 3 is a signal sequence diagram illustrating an example of signal flow associated with generating configuration information in a system environment according to an embodiment.

Referring to FIG. 3, according to an embodiment, in operation 301, an external device 200 in the system environment may have a state where the external device 200 is connected with a server device 300. For example, the external device 200 may establish a communication channel with a network connection device 370 of the server device 300. According to an embodiment, the external device 200 may establish a communication channel with the server device 300 based on a cellular network. Alternatively, the external device 200 may establish a communication channel with the server device 300 in an IoT communication scheme based on a limited bandwidth. Alternatively, the external device 200 may be connected to the server device 300 via a management device 220 of FIG. 1.

When connected to the server device 300, the external device 200 may provide device information of external devices included in the external device 200 to the server device 300. For example, the external device 200 may provide a device name of each of the external devices included in the external device 200, a state where each of the external devices is turned on or off, control information associated with controlling an action of each of the external devices, or the like to the server device 300. The server device 300 may store and manage the device information of each of the external devices in a device list 333 of FIG. 2. When there is a history where the external device 200 is connected to the server device 300 and when the external device 200 is disconnected from the server device 300 and is then connected with the server device 300 again, the external device 200 may provide only information about a current action state to the server device 300. The server device 300 may register and manage at least one external device based on a user account.

In operation 303, an electronic device 100 may access the server device 300 in response to a user input. The server device 300 may perform user authentication of the electronic device 100 which accesses the server device 300 and may provide a device list registered with a user account to the electronic device 100 depending on the performance of the user authentication. Receiving the device list from the server device 300, the electronic device 100 may output a screen interface (e.g., a configuration information screen) associated with inputting configuration information of at least one external device. The screen interface may include, for example, items for combining, correcting, or deleting configuration information of at least one external device. According to an embodiment, the screen interface may include an item for configuring an action of at least one external device to be performed according to a time interval.

When the input of the configuration information is completed through the screen interface, in operation 305, the electronic device 100 may generate configuration information associated with the at least one external device. The configuration information may be stored in a memory 130 of the electronic device 100.

In operation 307, the electronic device 100 may transmit the generated configuration information to the server device 300. When the configuration information is received, in operation 309, the server device 300 may update a configuration list. In this operation, the server device 300 may update a configuration list corresponding to a user account.

According to various embodiments, a server device may include at least one memory and at least one processor. The at least one processor may be configured to receive configuration information from a mobile device associated with a user account, the configuration information including a trigger condition (or a performance start condition) of a first action, a delay time of the first action, and a duration of the first action, receive an event (or an event message) from a first external device associated with the user account, when the received event meets the trigger condition of the first action, transmit first action information to start the first action to a second external device associated with the user account at a time when the delay time of the first action elapses from a time when the event is received, receive a first response indicating that the first action is started from the second external device, transmit a first notification associated with the first response to the mobile device, transmit second action information to end the first action at a time when the duration of the first action elapses from the time when the first action information is transmitted, receive a second response indicating that the first action is ended from the second external device, and transmit a second notification associated with the second response to the mobile device.

According to various embodiments, a server may include at least one memory storing configuration information associated with a user account, the configuration information including a trigger condition of a first action, a delay time of the first action, and a duration of the first action and at least one processor configured to be operatively with the at least one memory, wherein the at least one processor is configured to receive an event from a first external device associated with the user account, when the received event meets the trigger condition of the first action, transmit first action information to start the first action to a second external device associated with the user account at a time when the delay time of the first action elapses from a time when the event is received, and transmit second action information to end the first action to the second external device at a time when the duration of the first action elapses from the time when the first action information is transmitted.

According to various embodiments, the at least one processor may be configured to receive the configuration information from a mobile device associated with the user account.

According to various embodiments, the at least one processor may be configured to receive a first response indicating that the first action is started from the second external device, and transmit a first notification associated with the first response to the mobile device.

According to various embodiments, the at least one processor may be configured to receive a second response indicating that the first action is started from the second external device, and transmit a second notification associated with the second response to the mobile device.

According to various embodiments, the at least one processor may be configured to control to perform an action of at least one of the first external device and the second external device which are fixed devices.

According to various embodiments, the at least one processor may be configured to communicate with a mobile device over a cellular network to receive the configuration information, and communicate with the first external device and the second external device over an IoT network having a limited bandwidth to transmit the first action information or the second action information.

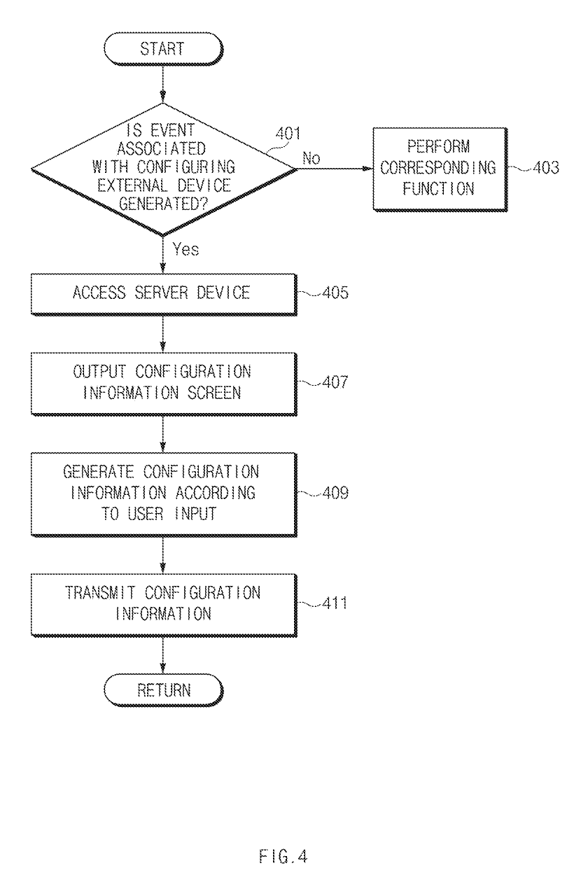

FIG. 4 is a flowchart illustrating an example of an operation method of an electronic device associated with generating configuration information in a system environment according to an embodiment.

Referring to FIG. 4, in operation 401, a processor 120 of FIG. 1 may determine whether an event for requesting to configure an external device is generated. For example, the processor 120 may determine whether an application associated with configuring the external device is executed. The application may include a browser associated with accessing a server device 300 of FIG. 1. When the generated event is unassociated with configuring the external device, in operation 403, the processor 120 may perform a function according to the event. For example, the processor 120 may perform a gallery function or may perform a camera function or a web access function, in response to a type of the event.

When the event associated with configuring the external device is generated, in operation 405, the processor 120 may access the server device 300. For example, when a user input for requesting to access the specified server device 300 occurs, the processor 120 may execute a web browser and may access the server device 300 through the web browser.

When the server device 300 provides data associated with inputting configuration information, in operation 407, the processor 120 may output a configuration information screen. The configuration information screen may include, for example, items for inputting a type of an action of at least one external device 200_1 to 200_N, a condition where the action is executed, or the like. According to an embodiment, the configuration information screen may include a delay configuration item for setting an interval of time (or setting an interval where an operation will continue) to perform an action depending on a time interval of the action or delaying a time when the action is executed.

In operation 409, the processor 120 may generate configuration information according to a user input. When a user input for selecting a specific item occurs on the configuration information screen including the above-mentioned items, the processor 120 may transmit information according to the user input to the server device 300. When there are additional selection items for an item selected according to the user input, the server device 300 may provide information about the items to an electronic device 100 of FIG. 1. When information about the additional selection item is received, the processor 120 may output a screen including the received information. When a user input for completing the input of configuration information about the at least one external device 200_1 to 200_N occurs, in operation 411, the processor 120 may transmit the configuration information to the server device 300.

According to various embodiments, an operation method of an electronic device may include accessing a server device based on a communication circuit of the electronic device and a specified user account, receiving a device list associated with at least one external device registered based on the user account from the server device, generating configuration information for controlling an action according to a time interval of at least one external device, based on the device list and a user input, and transmitting the configuration information to the server device.

According to various embodiments, the method may further include outputting a screen associated with generating the configuration information on a display of the electronic device.

According to various embodiments, the method may further include receiving a user input and outputting a screen including at least one of an item for setting a start time and an end time of a specified action of the at least one external device in response to the user input, an item for setting to delay the start time of the specified action of the at least one external device in response to the user input, or an item for setting to delay the end time of the specified action of the at least one external device in response to the user input.

According to various embodiments, the method may further include outputting an external device list selection screen to output notification information indicating a state where an action of the external device is performed.

According to various embodiments, the method may further include outputting a noti (or notification) of at least one of a type of an external device which performs the action and a state where an action of the external device is performed.

According to various embodiments, the method may further include outputting a combination item for combining a plurality of configuration information and combining the plurality of configuration information to operate a plurality of external devices included in an external device list together as a condition is met, in response to a user input associated with selecting the combination item or updating the plurality of configuration information to operate only some of the plurality of external devices.

According to various embodiments, the method may further include receiving a user input and outputting a configuration information screen including at least one of an item for setting at least one situation condition where an action of at least one external device will be executed, in response to the user input, an item for setting at least one time condition where the action of the at least one external device will be executed, or an item for setting a type of at least one action to be executed by the at least one external device.

According to various embodiments, the method may further include receiving an event which occurs in a specified external device and outputting at least one of a text, an image, or an audio indicating the event.

According to various embodiments, the method may further include receiving a response corresponding to a result of performing an action of a specified external device, depending on action information transmitted to the specified external device by the server device and outputting at least one of a text, an image, or an audio corresponding to the response.

According to various embodiments, the method may further include a screen including an item for inputting information about another electronic device to share operation of the configuration information.

According to various embodiments, the method may further include outputting a screen including an item for designating a location of at least one external device to apply the configuration information.

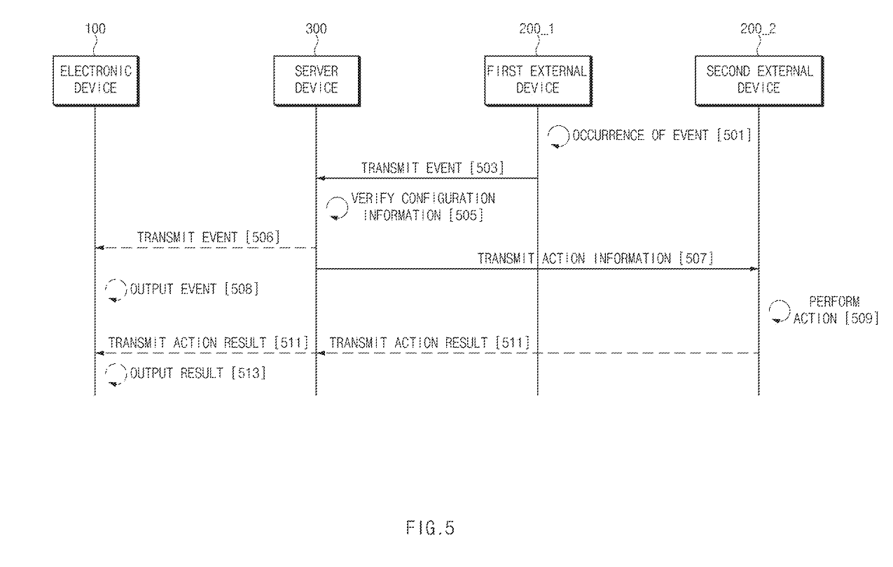

FIG. 5 is a signal sequence diagram illustrating an example of signal flow associated with performing an action of each of a plurality of external devices according to an embodiment.

Referring to FIG. 5, in a system environment, a first external device 200_1 and a second external device 200_2 may maintain a state where the first external device 200_1 and the second external device 200_2 are connected with a server device 300. Each of the first external device 200_1 and a second external device 200_2 may include IoT devices included in at least one external device 200_1 to 200_N.

In operation 501, the first external device 200_1 may obtain an event generated according to a specified condition. The event may include an event according to execution of a specified action. For example, the event may include an event where a door lock of a door device is released or where the door lock of the door device is set (e.g., when a door is auto-locked as it is closed). Alternatively, the event may include an event where a sensor which belongs to an external device obtains sensor information which meets (or satisfies) a specified condition (e.g., an event where a temperature meets a specific condition, an event where a specified type of gas is detected, an event where a specified time arrives, an event where a specified date arrives, an event where a state of a power device is changed, an event where vibration of a specified level or more is detected, or the like). The event may be generated according to execution of action information transmitted from the server device 300.

In operation 503, the first external device 200_1 may transmit the obtained event to the server device 300. In this operation, the first external device 200_1 may provide a user account associated with the first external device 200_1, its device information, or the like to the server device 300.

In operation 505, the server device 300 may verify configuration information associated with the received event. In this regard, the server device 300 may verify configuration information associated with the first external device 200_1 from a configuration list 331 of FIG. 2 and may collect information about an action to be performed according to the reception of the event from the configuration information. In this operation, the server device 300 may verify configuration information stored in the configuration list 331, based on device information of the first external device 200_1 or a user account provided from the first external device 200_1. The configuration information stored in the configuration list 331 may be associated and stored with the user account.

In operation 507, the server device 300 may transmit the collected action information to the second external device 200_2. For example, the server device 300 may collect information about an action configured to be performed when a specified event is received from the first external device 200_1 from configuration information. Further, the server device 300 may collect device information or device address information of the second external device 200_2 to which the action information is transmitted. The server device 300 may transmit the action information to the second external device 200_2 based on the collected device address information of the second external device 200_2.

In operation 509, the second external device 200_2 may perform an action according to the received action information. For example, when the second external device 200_2 is a power supply, it may be powered on according to action information. Alternatively, when the second external device 200_2 is an air conditioner, it may perform a cooling function for temperature control depending on action information.

In operation 511, the second external device 200_2 may transmit the result of performing the action or a response to the server device 300. In this operation, the second external device 200_2 may provide device information or user account information together with the result of performing the action or the response to the server device 300. After transmitting the response, the second external device 200_2 may continue performing a specified action based on the action information or may end the specified action.

According to various embodiments, after verifying the configuration information, in operation 506, the server device 300 may transmit the event, received from the first external device 200_1, to the electronic device 100. In this operation, the server device 300 may transmit at least one of text information and audio information indicting the received event to the electronic device 100.

In operation 508, the electronic device 100 may output at least one of a text, an image, and an audio corresponding to the received event. For example, the electronic device 100 may output at least one of a text and an image indicating contents of the event on a display 160 of FIG. 1. Alternatively, the electronic device 100 may output an audio indicating contents of the event, through an input/output interface 150 of FIG. 1 (e.g., an audio device).

In operation 511, the electronic device 100 may receive the result of performing the action and the response from the server device 300 or the second external device 200_2. When receiving a response from the second external device 200_2, the server device 300 may verify a user account and may provide the response (or text or audio information indicating the response) to the electronic device 100 based on the verified user account.

In operation 513, the electronic device 100 may output the received result of performing the action or the received response. For example, the electronic device 100 may output at least one of a text and an image indicating the result of performing the action or the response on the display 160 or may output audio information indicating the result of performing the action or the response through an audio device.

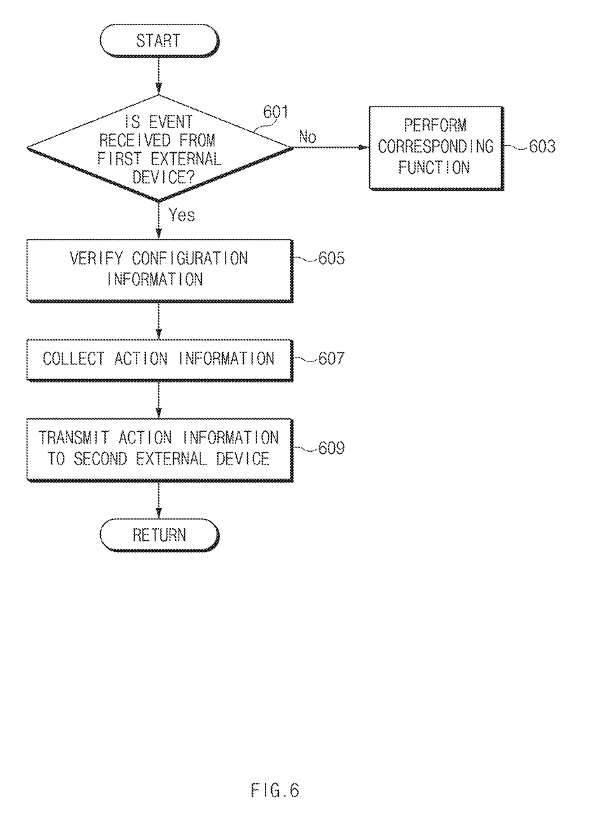

FIG. 6 is a flowchart illustrating an example of an operation method of a server device associated with performing an action of each of a plurality of external devices according to an embodiment.

Referring to FIG. 6, in operation 601, a server processor 320 of FIG. 2 may determine whether an event is received from a first external device 200_1 of FIG. 1. When the event is not received, in operation 603, the server processor 320 may perform a specified function. For example, when a new external device accesses a server device 300 of FIG. 1, the server processor 320 may obtain information about a user account with which the external device which accesses the server device 300 is registered (e.g., information about a user account by a user input). Alternatively, when a previously registered external device is unregistered, the server processor 320 may delete information associated with the unregistered external device from a device list and a configuration list.

When the event is received from the first external device 200_1, in operation 605, the server processor 320 may verify configuration information. In this regard, the server processor 320 may obtain configuration information associated with the first external device 200_1 from the configuration list based on device information of the first external device 200_1 or a user account associated with the first external device 200_1.

In operation 607, the server processor 320 may collect action information. The server processor 320 may verify whether an event is received from the first external device 200_1, from the obtained configuration information, and may collect information about a second external device 200_2 of FIG. 1 and information about an action to be performed by the second external device 200_2 in response to the reception of the event. The information about the second external device 200_2 may include address information of the second external device 200_2 to transmit the action information to the second external device 200_2.

In operation 609, the server processor 320 may transmit the action information to the second external device 200_2. In addition, the server processor 320 may receive the result of performing an action or a response from the second external device 200_2 and may transmit the received result of performing the action or the received response to the electronic device 100 or a specified third external device.

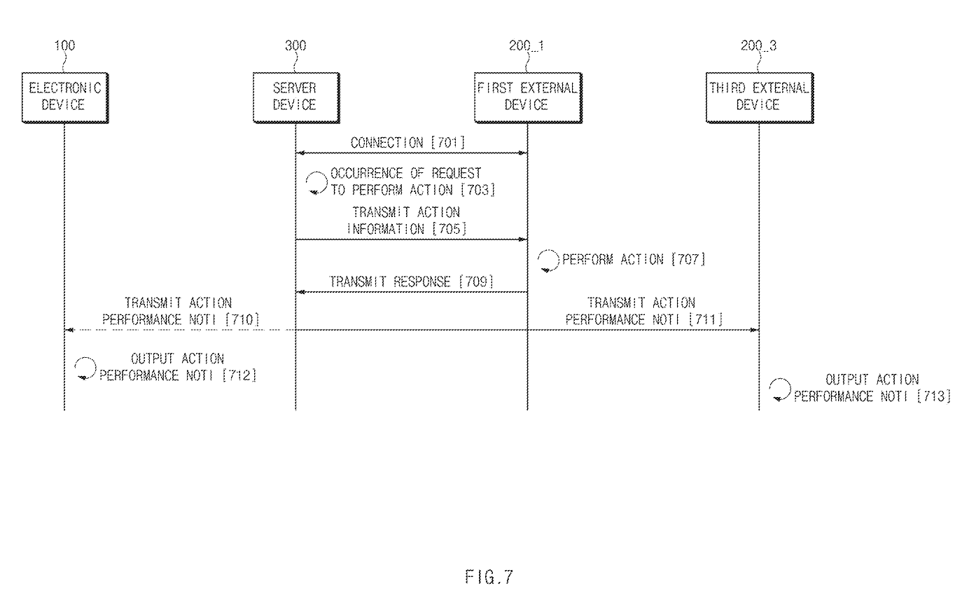

FIG. 7 is a signal sequence diagram illustrating an example of signal flow associated with a noti (or notification) output according to performing an action of an external device, according to an embodiment.

Referring to FIG. 7, in operation 701, a first external device 200_1 may have a state where the first external device 200_1 is connected with a server device 300. For example, the first external device 200_1 may have the state where the first external device 200_1 is connected with the server device 300, based on an IoT communication scheme. According to various embodiments, the first external device 200_1 may have the state where the first external device 200_1 is connected with the server device 300, via a management device 220 of FIG. 1 (or a hub).

In operation 703, the server device 300 may verify an event according to occurrence of a request to perform an action in connection with the first external device 200_1. When an event where a specified time of configuration information registered with a configuration list 331 of FIG. 2 arrives occurs, the server device 300 may obtain the event. Alternatively, the server device 300 may receive an input for requesting to perform an action of the first external device 200_1 from an electronic device 100 or a specific external device which accesses the server device 300 (e.g., a device including an input interface for requesting to perform an action of a specified external device). A user may perform a user input operation for requesting to perform an action of the first external device 200_1 using his or her electronic device (or portable terminal) or using an external device adjacent to him or her.

In operation 705, the server device 300 may collect action information indicated by the request to perform the action (e.g., action information obtained from configuration information or action information obtained by a user input) and may transmit the collected action information to the first external device 200_1.

In operation 707, the first external device 200_1 may perform an action corresponding to the received action information. In operation 709, the first external device 200_1 may transmit a response corresponding to the result of performing the action or a response corresponding to the result to the server device 300. For example, when the first external device 200_1 is a power supply and is changed in its power state according to performance of an action, the first external device 200_1 may transmit information about the changed power state to the server device 300. Alternatively, when the first external device 200_1 is a cleaner, the first external device 200_1 may perform cleaning depending on performance of an action and may transmit the result of performing the cleaning to the server device 300.

According to various embodiments, in operation 711, the server device 300 may transmit an action performance noti (or notification) according to the performance of the action to a third external device 200_3. The action performance noti may include information (e.g., a text, an image, or an audio) indicating the above-mentioned result of performing the action. The third external device 200_3 may include at least one of a display or an audio device capable of outputting the action performance noti.

In operation 713, the third external device 200_3 may output the received action performance noti. For example, the third external device 200_3 may output at least one of a text, an image, or an audio corresponding to the action performance noti through at least one of a display and an audio device of the third external device 200_3. The action performance noti may be output a specified number of times or during a specified time. Alternatively, the action performance noti may be output until a user input for requesting to stop performing the action occurs through the third external device 200_3.

According to various embodiments, after receiving the response, in operation 710, the server device 300 may transmit the action performance noti to the electronic device 100. In this regard, the server processor 320 may verify a user account of the third external device 200_3 which receives the action performance noti and may obtain address information (e.g., a phone number) of the electronic device 100 associated with the user account. The action performance noti may be transmitted in the form of, for example, a text or image or may be transmitted in the form of audio information converted into a voice of a specified gender.

In operation 712, the electronic device 100 may output the received action performance noti. The electronic device 100 may output the received action performance noti through at least one of a display 160 of FIG. 1 and an audio device. Alternatively, the electronic device 100 may output the received action performance noti as a specific element depending on a setting state. When an information arrival notification of the electronic device 100 is set to vibration, the electronic device 100 may output a text or image corresponding to the action performance noti on the display 160. When the information arrival notification of the electronic device 100 is set to a sound, the electronic device 100 may output audio information corresponding to the action performance noti through the audio device. According to various embodiments, when the information arrival notification of the electronic device 100 is set to silence or non-vibration, the electronic device 100 may store the received action performance noti in a memory 130 of FIG. 1 and may omit a separate notification output.

In the above-mentioned operation, the server processor 320 may transmit the action performance noti to only the electronic device 100, or may transmit the action performance noti to the electronic device 100 and may then transmit the action performance noti to the third external electronic device 200_3 after a specified time. Alternatively, the server processor 320 may transmit the action performance noti to the third external device 200_3 and may then the action performance noti to the electronic device 100 after a specified time, or may simultaneously transmit the action performance noti to the electronic device 100 and the third external device 200_3.

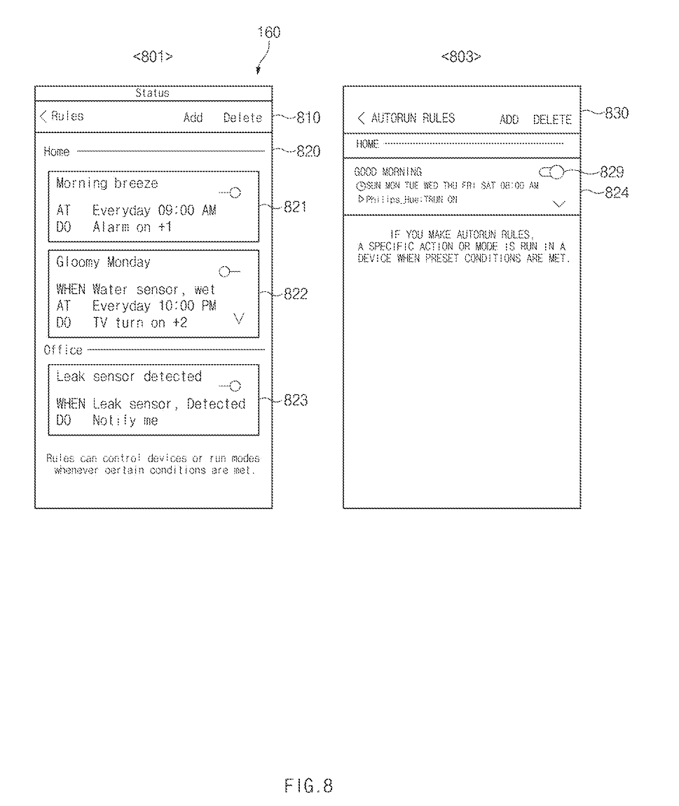

FIG. 8 is a drawing illustrating an example of a screen including configuration information according to an embodiment.

Referring to FIG. 8, a screen described hereafter may include information provided by a server device 300 of FIG. 1. The screen may be output on an electronic device 100 of FIG. 1, a management device 220 of FIG. 1, or at least one external device including a display, which accesses the server device 300. A user may configure an action of the at least one external device through the electronic device 100, the management device 220, or the at least one external device. In a description hereafter, an embodiment is exemplified as the screen is output on a display 160 of the electronic device 100. When the electronic device 100 accesses the server device 300 with a specified user account, the server device 300 may provide a device list and a configuration list registered with the user account to the electronic device 100.

When the electronic device 100 accesses the server device 300 in response to execution of an application associated with configuring the action of the at least one external device, the server device 300 may provide a server page associated with configuring the action of the at least one external device to the electronic device 100. Alternatively, the electronic device 100 may output a screen (e.g., screen information stored in a memory 130 of FIG. 1) associated with configuring the action of the at least one external device, as shown in FIG. 8, on the display 160 in response to a user input without accessing the server device 300. When configuration information is generated as the action configuration is completed, the electronic device 100 may transmit the generated configuration information to the server device 300. In this operation, the electronic device 100 may receive a device list 333 and a configuration list 331 from the server device 300 and may compare the device list 333 and the configuration list 331 with a device list and a configuration list which are previously stored to update or maintain previously stored information.

When action configuration is requested (e.g., when the electronic device 100 executes an application associated with the action configuration and accesses the server device 300), like screen 801, a processor 120 of the electronic device 100 may output a configuration information screen including at least one configuration information (or rule) on the display 160. The configuration information screen may include a configuration region 810 and a plurality of configuration information 820. The configuration region 810 may include an “add” item or a “delete” item of configuration information. The plurality of configuration information 820 may include first configuration information 821 and second configuration information 822 which are registered in connection with a home and third configuration information 823 registered in connection with an office. According to various embodiments, each of a home region and an office region may be a default region in connection with the configuration information screen and may correspond to a region provided by the electronic device 100. When a user wants to add configuration information associated with the home region, he or she may generate the configuration information associated with the home region. Further, when the user wants to add configuration information associated with the office region, he or she may generate the configuration information associated with the office region. Configuration information generated for each location may be added to the home region or the office region.

A form arranged on the home region or the office region may be changed according to a location of the electronic device 100. For example, when the electronic device 100 is currently located in an office, the office region may be located above the home region on the configuration information screen of the display 160. According to various embodiments, a name of each of the home region and the office region may be changed according to a user input. For example, the “home” indicating the home region may be changed to the “my home” or the like. According to various embodiments, a new region, for example, a dormitory region or the like may be further included according to a user input. When the electronic device 100 of the user is located in a dormitory, the dormitory region may be located above the home region or the office region.

The first configuration information 821 may include, for example, a configuration information name (e.g., Morning breeze), a time condition (e.g., AT: Everyday 09:00 AM), and an action (e.g., DO: Alarm on +1). The time condition may include a condition for defining a time when the first configuration information 821 is performed. The action may include, for example, an operation of outputting an alarm. The “+1” may indicate that there are one more action which should be performed in the first configuration information 821. When the first configuration information 821 is selected, action information (e.g., TV Turn on) corresponding to the “+1” may be displayed.

The second configuration information 822 may include, for example, a configuration information name (e.g., Gloomy Monday), a situation condition (e.g., WHEN: Water sensor, wet), a time condition (e.g., AT: Monday 10:00 PM), and an action (e.g., DO: TV Turn on +2). The situation condition may include a condition where a specified external device performs an action of the second configuration information 822 (e.g., a condition where a moisture sensor senses moisture of a specified level or more). The action may include, for example, an operation of turning on a TV. The “+2” may indicate that there are two more actions which should be performed in the second configuration information 822. When the second configuration information 822 is selected, two action information corresponding to the “+2” may be displayed through expansion of the second configuration information 822.

The third configuration information 823 may include, for example, a configuration information name (e.g., Leak sensor detected), a situation condition (e.g., WHEN: Leak sensor, Detected), and an action (e.g., DO: Notify me). The situation condition may include, for example, a situation where a leak sensor among at least one external device detects a leak of a gas or liquid of a specified concentration or more or detects a short circuit. The action may include an operation of transmitting a leak or short circuit notification of a gas or liquid to a specified electronic device (e.g., a portable terminal of the user). In this regard, a phone number of the portable terminal of the user may be linked to the action.

According to various embodiments, when an action configuration is requested, the processor 120 of the electronic device 100 may output a configuration information screen including configuration information (or autorun rules) like screen 803. In this regard, the processor 120 may obtain the most recently updated configuration list from the server device 300 and may output the configuration information screen based on the obtained configuration list.

The configuration information screen may include, for example, a configuration region 830 and fourth configuration information 824. As described above, the configuration screen 830 may include an “add” item and a “delete” item of configuration information. The fourth configuration information 824 may be information configured in connection with a home and may include a configuration information name (e.g., Good Morning), a time condition (e.g., Sun, Mon, Tue, Wed, Thu, Fri, Sat 08:00 AM) and an action (e.g., Philips_Hue: Turn on). The above-mentioned fourth configuration information 824 may include, for example, information configured to perform an action of turning on an external device (e.g., a lamp) “Philips_Hue” at 8 a.m. daily.

The user may select and delete any one of the first to fourth configuration information 821 to 824, add new configuration information (e.g., add new configuration information using the “add” item), or may correct contents of the first to fourth configuration information 821 to 824 (or a condition or a type of an external device). Further, the user may determine whether to apply the first to fourth configuration information 821 to 824. For example, whether to apply the first to fourth configuration information 821 to 824 may be determined according to whether an activation button 829 provided together with a configuration information name is selected. When it is determined that the first to fourth configuration information 821 to 824 are applied, the electronic device 100 may transmit configuration information updated according to the determination that the first to fourth configuration information 821 to 824 are applied to the server device 300.

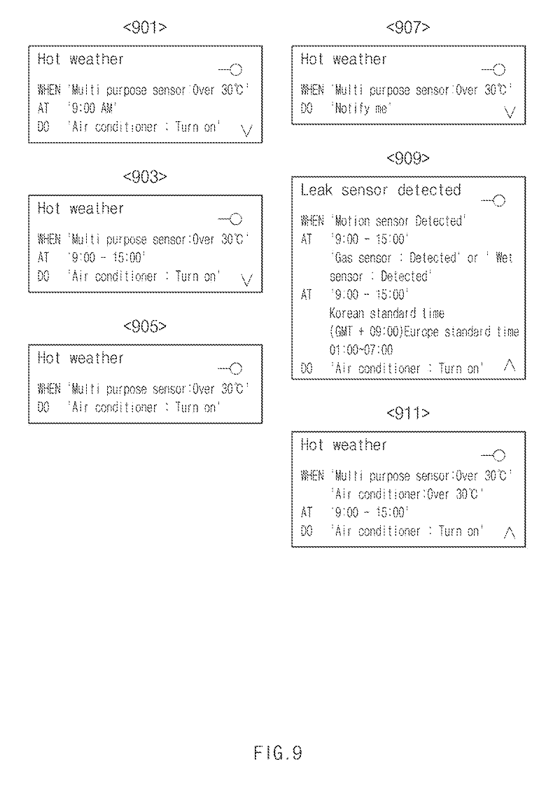

FIG. 9 is a drawing illustrating an example of another configuration information according to an embodiment.

Referring to FIG. 9, an electronic device 100 of FIG. 1 may correct or delete at least one configuration information based on a configuration list stored in a server device 300 of FIG. 1. Alternatively, the electronic device 100 may generate new configuration information. Thus, the server device 300 may store a variety of configuration information. For example, configuration information 901 may include a configuration information name (e.g., Hot weather), a situation condition (e.g., WHEN: ‘Multi-purpose sensor: Over 30 degrees’), a time condition (e.g., AT: 9:00 AM), and an action (e.g., DO: Air conditioner: turn-on). The above-mentioned configuration information 901 may include actions configured to check a temperature using a multi-purpose sensor at 9 a.m. daily and turn on an air conditioner when the temperature is over 30 degrees. When the above-mentioned configuration information 901 is registered with a configuration list, the server device 300 may activate the multi-purpose sensor among external devices registered with a user account at 9 a.m. daily and may collect temperature information from the multi-purpose sensor. When the collected temperature information is over 30 degrees, the server device 300 may transmit information about an action for turning on the air conditioner among the external devices registered with the same user account to the air conditioner. The air conditioner may be turned on to perform an air cleaning function or a temperature adjustment function depending on a specified setting.

According to various embodiments, configuration information 903 may include a configuration information name (e.g., Hot weather), a situation condition (e.g., WHEN: ‘Multi-purpose sensor: Over 30 degrees’), a time interval condition (e.g., During: 9:00-15:00), and an action (e.g., DO: Air conditioner: turn-on). The above-mentioned configuration information 903 may include actions configured to check a temperature in real time using a multi-purpose sensor from 9 a.m. to 3 p.m. daily and turn on an air conditioner when the temperature is over 30 degrees. When the above-mentioned configuration information 903 is registered with a configuration list, the server device 300 may activate the multi-purpose sensor among external devices registered with a user account in a real time or at intervals of a constant time between 9 a.m. and 3 p.m. daily and may collect temperature information from the multi-purpose sensor. Alternatively, the server device 300 may keep the multi-purpose sensor activated from 9 a.m. to 3 p.m. and may receive temperature information when a temperature is over 30 degrees. When the collected temperature information is over 30 degrees, the server device 300 may transmit information about an action for turning on the air conditioner among the external devices registered with the same user account to the air conditioner. In addition, when receiving temperature information (e.g., 26 degrees) as temperature information fails to a specified value or less (e.g., 30 degrees, 26 degrees, or the like) from the multi-purpose sensor, the server device 300 may transmit information about an action for turning off the air conditioner to the air conditioner.

According to various embodiments, configuration information 905 may include a configuration information name (e.g., Hot weather), a first situation condition (e.g., WHEN: ‘Multi-purpose sensor: Over 30 degrees’), and a first action (e.g., DO: Air conditioner: turn-on). The above-mentioned configuration information 905 may include an action configured to turn on an air conditioner when a temperature is over 30 degrees, as a multi-purpose sensor detects the temperature. When the above-mentioned configuration information 905 is registered with a configuration list, the server device 300 may transmit information about an action for turning on the air conditioner among external devices registered with the same user account to the air conditioner, based on temperature information provided in a state where a temperature detected by the multi-purpose sensor of an activated state is over 30 degrees. The air conditioner may be turned on according to the action information to perform an air cleaning function or a temperature control function depending on a specified setting. In addition, the configuration information 905 may further include a second situation condition (e.g., WHEN: ‘Multi-purpose sensor: Under 26 degrees’) and a second action (e.g., DO: Air conditioner: turn-off). When the configuration information including the second situation condition and the second action is registered and when receiving information about a temperature value of 26 degrees or less from the multi-purpose sensor registered with the user account, the server device 300 may transmit information about an action for turning off the air conditioner registered with the same user account to the air conditioner.

According to various embodiments, configuration information 907 may include a configuration information name (e.g., Hot weather), a situation condition (e.g., WHEN: ‘Multi-purpose sensor: Over 30 degrees’), and an action (e.g., DO: Notify me). The above-mentioned configuration information 907 may include an action configured to notify a portable terminal of a user that a temperature is over 30 degrees (e.g., an action configured to transmit a message to the portable terminal to output a specified alarm), when the temperature is over 30 degrees as a multi-purpose sensor detects the temperature. When the above-mentioned configuration information 907 is registered with a configuration list, the server device 300 may transmit notification information (or noti information) to an electronic device 100 (or a portable terminal) registered with the same user account, based on temperature information provided in a state where a temperature detected by the multi-purpose sensor of an activated state is over 30 degrees. The notification information may be output through at least one of a display 160 and an audio device of the electronic device 100.

According to various embodiments, configuration information 909 may include a configuration information name (e.g., Leak sensor detected), a situation condition (e.g., WHEN: ‘Motion sensor: Detected’, ‘Gas sensor: Detected’, or ‘Wet sensor: Detected’), a time condition (e.g., AT: ‘9:00-15:00’ Korean standard time (GMT+09:00) Europe standard time 01:00-07:00), and an action (e.g., DO: ‘Air conditioner: turn-on’). The above-mentioned configuration information 909 may include an action configured to turn on an air conditioner when a motion detection value, a gas detection value, or a moisture detection value defined in the situation condition is over a specified value from 9 a.m. to 3 p.m. with respect to the Korean standard time and from 1 a.m. to 7 a.m. with respect to the Europe standard time in connection with the time condition. When the above-mentioned configuration information 909 is registered with a configuration list, the server device 300 may transmit action information to maintain at least one of a motion sensor, a gas sensor, a wet sensor (a sensor for humidity detection) defined in the situation condition in a turn-on state during a time defined in the time condition. The server device 300 may verify sensor information provided by at least one of the sensors. When the received sensor information is over a specified value, the server device 300 may transmit information about an action of activating the air conditioner to the air conditioner. The sensors, the air conditioner, and the like may be registered with the same user account.

According to various embodiments, configuration information 911 may include a configuration information name (e.g., Hot weather), a situation condition (e.g., WHEN: ‘Multi-purpose sensor: 30 degrees’ and ‘Air conditioner: 30 degrees’), a time condition (e.g., AT: ‘09:00-15:00’), and an action (e.g., DO: ‘Air conditioner: Turn-on’). The above-mentioned configuration information 911 may include an action of activating a multi-purpose sensor and a temperature detector of an air conditioner, an action of verifying whether a temperature value is over 30 degrees, or an action of activating the air conditioner when the temperature is over 30 degrees. When the configuration information 911 is registered, the server device 300 may detect a temperature using at least one of the multi-purpose sensor and the air conditioner among external devices registered with a user account of the configuration information 911. In this operation, the server device 300 may simultaneously operate the multi-purpose sensor and the temperature detector of the air conditioner to detect a temperature or may detect a temperature using any one of the multi-purpose sensor or the temperature detector of the air conditioner. When sensor information which is over a specified temperature value (e.g., 30 degrees) is received, the server device 300 may activate another external device (e.g., the temperature detector of the air conditioner when the multi-purpose sensor is first used) to verify whether a temperature value is over 30 degrees. When the temperature value is over 30 degrees, the server device 300 may transmit information about an action associated with controlling a temperature control function of the air conditioner to the air conditioner.

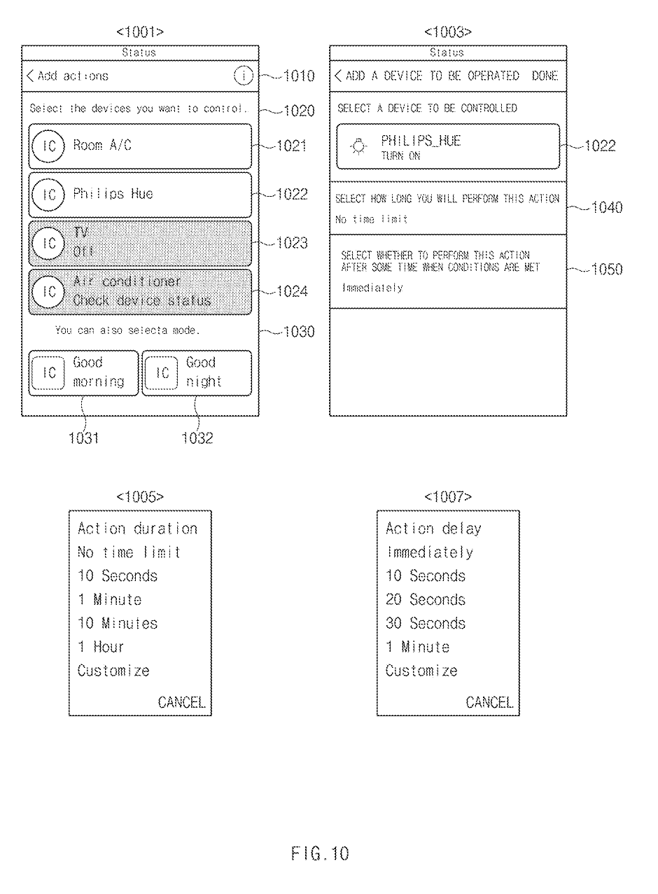

FIG. 10 is a drawing illustrating an example of a screen interface associated with configuring a time interval of an action according to an embodiment.

Referring to FIG. 10, like screen 1001, an electronic device 100 of FIG. 1 may output a configuration information screen associated with generating or correcting configuration information of at least one external device. For example, as shown, the configuration information screen may include a title region 1010, a device list region 1020, and a mode region 1030.

The title region 1010 may include contents associated with attributes of a currently displayed screen (e.g., a screen for adding an action). The device list region 1020 may include a first device item 1021, a second device item 1022, a third device item 1023, and a fourth device item 1024. The first device item 1021 may include an item for configuring an action of each of devices associated with a specified room. For example, the first device item 1021 may be an item for configuring an action of each of a plurality of external devices located in the specified room of a home. When the first device item 1021 is selected, a new page or a pop-up window may be output to configure an action of each of a plurality of external devices registered with the first device item 1021. The second device item 1022 may be an item for configuring an action of a specified external device (e.g., Philips Hue or a power supply). The third device item 1023 may be an item for configuring an action of a specified external device (e.g., a TV, a turn-off state). The fourth device item 1024 may be an item for configuring an item for configuring an action of a specified external device (e.g., an air conditioner, a request to check a status). The third device item 1023 may be displayed to be different from (e.g., to be darker than) another device item (e.g., the first device item 1021 or the second device item 1022) as the external device is in a turn-off state or in a state where the external device is not connected with a server device 300 of FIG. 1. The fourth device item 1024 may be displayed to be different from another device item (e.g., the first device item 1021 or the second device item 1022) as the external device is abnormal (e.g., as the external device does not perform an operation according to a specified scheduling state, as the external device fails, or as the external device is not connected to the server device 300).

The mode region 1030 may include items for correcting or deleting configuration information, for example, a first configuration information item 1031 and a second configuration information item 1032. As described with reference to FIG. 9, the first configuration information item 1031 and the second configuration information item 1032 may include configuration information where various situation conditions, various time conditions, and an action of at least one external device are configured. When the configuration information item is selected, configuration information corresponding to the selected item may be display on a display 160 of FIG. 1.

According to various embodiments, the electronic device 100 may output screen 1003 associated with setting a time interval of an action. For example, when the second device item 1022 is selected, the electronic device 100 may output a screen associated with setting a time interval of the second device item 1022. The screen associated with setting the time interval may include, for example, the second device item 1022, an interval configuration item 1040, and a delay configuration item 1050. The second device item 1022 may display an action configuration state (e.g. turn-on state).

When the interval configuration item 1040 is selected, like screen 1005, the electronic device 100 may output a pop-up or a page for configuring an interval on the display 160. The interval configuration item 1040 may include, for example, a “no time limit” option, a “10 second” option, a “1 minute” option, a “10 minutes” option, a “1 hour” option, and a “customize” option. The “no time limit” option may be used to designate an external device corresponding to the second device item 1022 to be in a turn-on state continuously. The “customize” option may be used for a user to directly input a time for a turn-on state of an external device of the second device time 1022.

When the delay configuration item 1050 is selected, like screen 1007, the electronic device 100 may output a pop-up or a page for setting a delay time on the display 160. The delay configuration item 1050 may include, for example, an “immediately” option, a “post-10-second” option, a “post-20-second” option, a “post-30-second” option, a “post-1-minute” option, and a “customize” option. The “immediately” option may be used to configure an external device corresponding to the second device time 1022 to immediately perform the action configuration state (e.g., a turn-on state) concurrently with generating the configuration information. The “customize” option may be used for the user to directly input a delay interval of a time when the external device corresponding to the second device item 1022 is turned on.

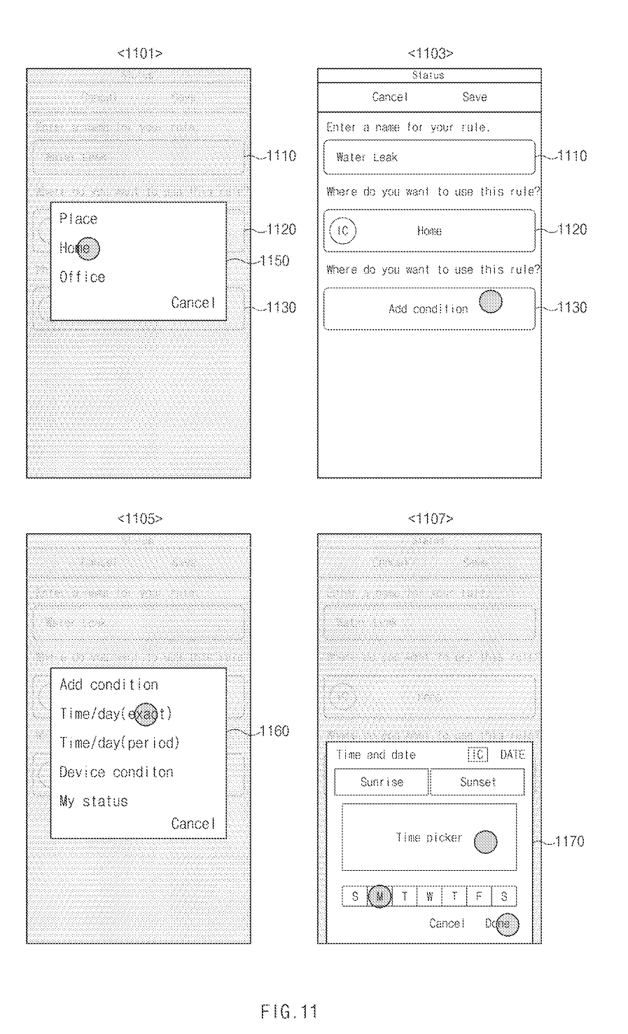

FIG. 11 is a drawing illustrating an example of a screen interface associated with generating configuration information according to an embodiment.

Referring to FIG. 11, when an item associated with generating configuration information is selected in a state where an application associated with controlling the configuration information of an external device is executed or when a request to generate new configuration information is input through a server page provided by a server device 300 of FIG. 1, the application or the server device 300 may provide a screen associated with generating the configuration information to an electronic device 100 of FIG. 1.

Like screen 1101 or 1103, the electronic device 100 may output a configuration information generation screen including a region 1110 for inputting a configuration information name, a region 1120 for inputting a configuration information application location, and an action configuration region 1130. After the input of a text (e.g., Water leak) according to a user input, to the region 1110 for inputting the configuration information name, is completed, the region 1120 for inputting the configuration information application location may be selected. In this case, as shown, a processor 120 of the electronic device 100 may output a location selection region 1150 for inputting a location (e.g., a pop-up window for selecting any one of ‘Home’ or ‘Office’). According to various embodiments, more location items may be displayed on the location selection region 1150 depending on a user input. Alternatively, the location selection region 1150 may include a current location as an item. When a ‘Home’ item is selected on the location selection region 1150, like screen 1103, the ‘Home’ may be entered in the location input region 1120 of the configuration information generation screen.

When the action configuration region 1130 is selected, like screen 1105, the processor 120 of the electronic device 100 may output a condition selection region 1160 for selecting action configuration conditions (e.g., a pop-up window including a ‘Time/day(exact)’ item for designating a time/day as a corresponding time and day, a ‘Time/day(period)’ item for designating a time/day as a constant period, a ‘Device condition’ item for designating a state where a device is executed (e.g. a turn-on or turn-off state), or a ‘My status’ item for designating a user status). The ‘My status’ item may be for determining a status of the user based on sensor information obtained by at least one sensor included in the electronic device 100 and may be for designating, for example, a state where the user is going home, a state where he or she goes out, a state where he or she is going to work, a state where he or she awakes from his or her sleep, a state where he or she goes to sleep, a state where he or she takes exercise, or the like.

When the ‘Time/day(exact)’ item for designating the time/day as the corresponding time and day is selected, like screen 1107, the processor 120 of the electronic device 100 may output a time selection region 1170 for selecting a time/day.

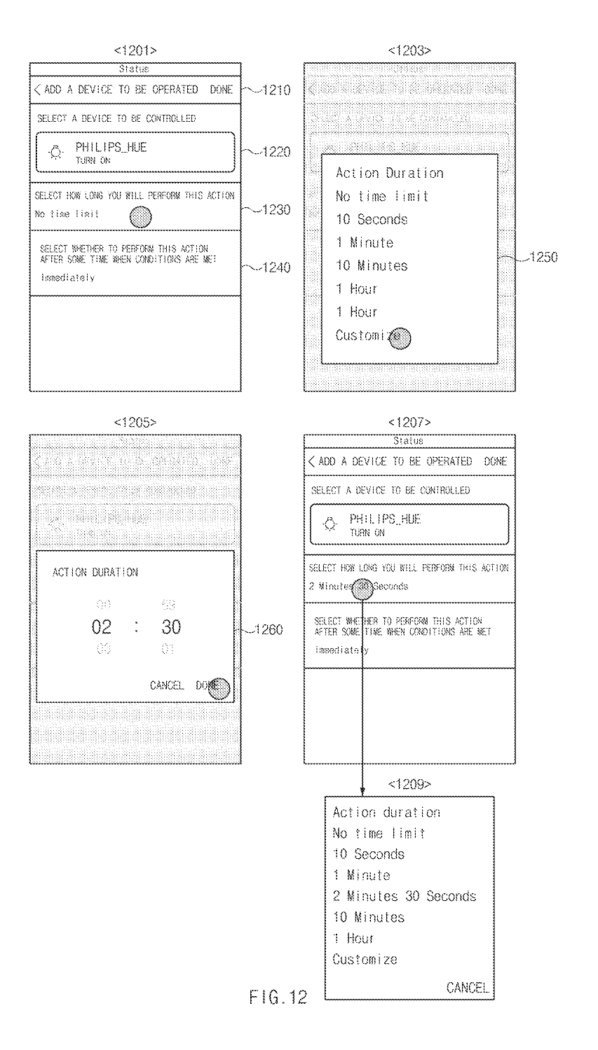

FIG. 12 is a drawing illustrating an example of a screen interface associated with correcting a time interval according to an embodiment.

Referring to FIG. 12, in connection with correcting configuration information of at least one external device, like screen 1201, an electronic device 100 of FIG. 1 may output a configuration information screen of a specified external device. Alternatively, when a specific device item is selected from at least one list, a configuration information screen corresponding to the device item may be output as shown.

The configuration information screen may include, for example, a screen title region 1210 (e.g., “add a device to be operated”), a device item region 1220 (e.g., “Philips Hue, turn on”), an interval configuration region 1230 (e.g., “No time limit”), and a delay configuration region 1240 (e.g., “immediately”). When the interval configuration region 1230 is selected, like screen 1203, the electronic device 100 may output an option selection region 1250 (e.g., a pop-up window) associated with interval configuration. The option selection region 1250 may include, for example, a “no time limit” option, a “10 seconds” option, a “1 minute” option, a “10 minutes” option, a “1 hour” option, and a “customize” option.

The “customize” option is selected, like screen 1205, the electronic device 100 may output an action interval selection region 1260 for designating a turn-on action interval of a device (e.g., Philips Hue) written in the device item region 1220. A user may perform a user input (e.g., touch) in connection with the action interval selection region 1260 to select a desired action interval (e.g., 2 minutes 30 seconds).

In response to the completion of the selection of the action interval, like screen 1207, an action interval value of the interval configuration region 1230 may be changed from “No time limit” to “2 minutes 30 seconds” on the configuration information screen. When the interval configuration region 1230 is selected again on screen 1207, like 1209, the option selection region 1250 to which a “2 minutes 30 seconds” option is added may be output.

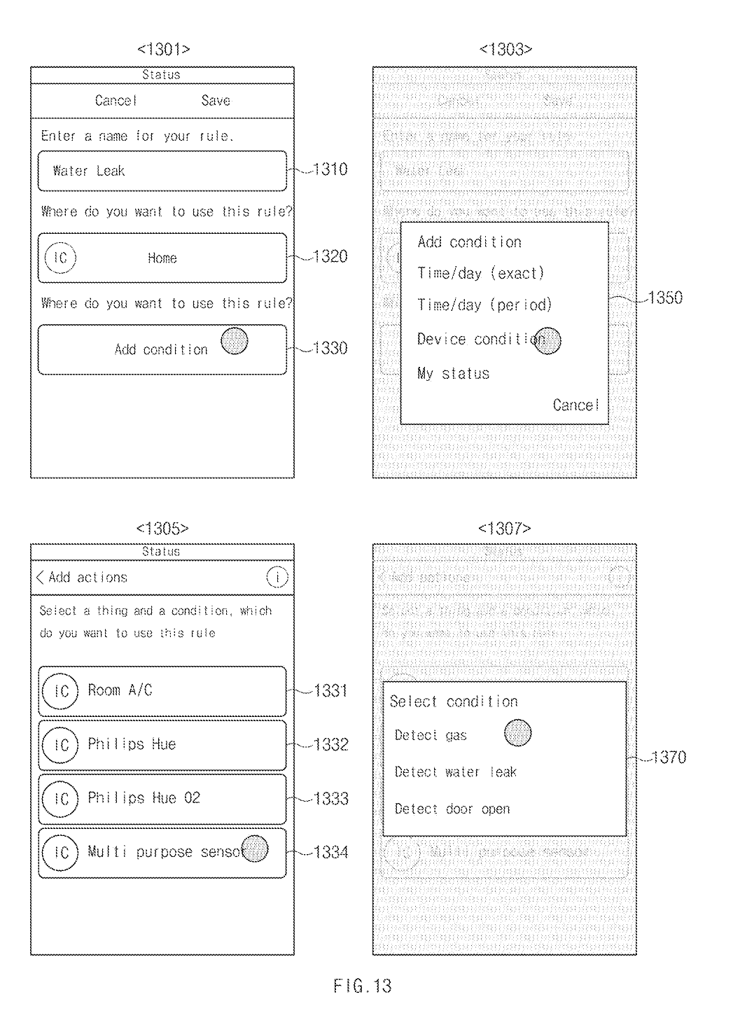

FIG. 13 is a drawing illustrating an example of a screen interface associated with configuring a complex action of external devices according to an embodiment.

Referring to FIG. 13, in connection with correcting or generating configuration information, an electronic device 100 of FIG. 1 may output a configuration information screen like screen 1301. The electronic device 100 may output a configuration information generation screen including, for example, a region 1310 for inputting a configuration information name, a region 1320 for inputting a configuration information application location, and an action configuration region 1330. In response to a user input, specified name information (e.g., “Water Leak”) may be entered in the region 1310 for inputting the configuration information name. In response to a user input, the “Home” may be entered in the region 1320 for inputting the configuration information application location.

According to various embodiments, when the action configuration region 1330 is selected, like screen 1303, a processor 120 of the electronic device 100 may output a condition selection region 1350 for selecting action configuration conditions (e.g., a pop-up window including a “Time/day(exact)” item, a “Time/day(period)” item, a “Device condition” item, and a “My status” item). The “Device condition” item corresponding to a device condition is selected, like screen 1305, the processor 120 of the electronic device 100 may output a device list screen (e.g., a screen including a first device item 1331 (e.g., Room A/C), a second device item 1332 (e.g., Philips Hue), a third device item 1333 (e.g., Philips Hue 02), and a fourth device item 1334 (e.g., Multi-purpose sensor)). The device list screen may include information of at least one external device registered with a user account associated with the electronic device 100. According to various embodiments, the device list screen may include the first device item 1331 (e.g., Room A/C) including a plurality of devices included in a specified location (e.g., a specific room in a home).

When a user input of selecting the fourth device item 1334 is received, like screen 1307, the processor 120 of the electronic device 100 may output a function selection region 1370 (e.g., a pop-up window) including a plurality of function items (e.g., a ‘Detect gas’ item, a ‘Detect water leak’ item, and a ‘Detect door open’ item) capable of being provided by a corresponding device. When a specific item (e.g., the “Detect gas” item) among the plurality of function items is selected, the processor 120 of the electronic device 100 may include condition configuration associated with gas detection in configuration information. The function selection region 1370 may support to select a plurality of function items in response to a user input. Thus, a user may perform, for example, a user input to include a plurality of items (e.g., a ‘Detect gas’ item, a ‘Detect door open’ item, and the like) in configuration information.

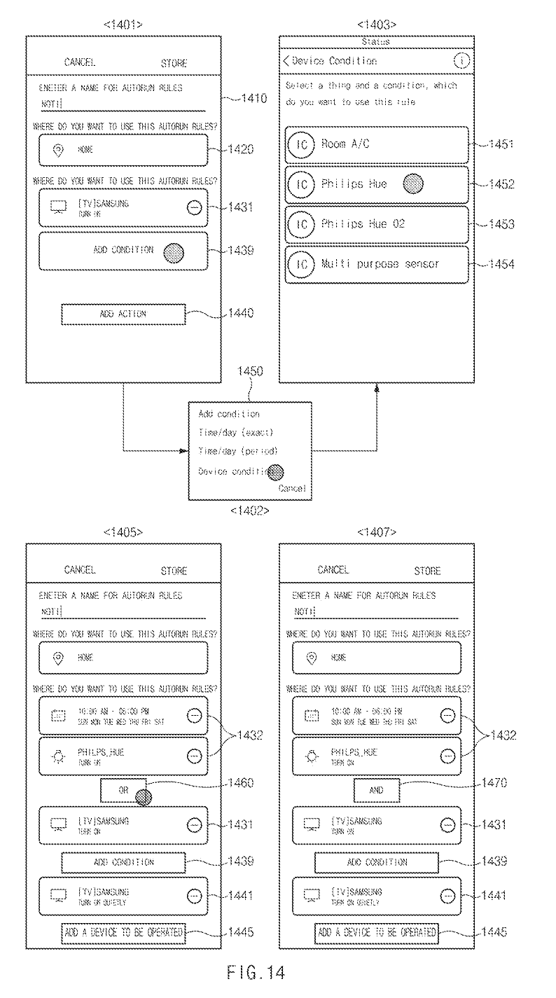

FIG. 14 is a drawing illustrating another example of a screen interface associated with configuring a complex action of external devices according to an embodiment.

Referring to FIG. 14, in connection with correcting or generating configuration information, a processor 120 of an electronic device 100 of FIG. 1 may output a configuration information screen like screen 1401. The processor 120 of the electronic device 100 may output a configuration information generation screen including a region 1410 for inputting a configuration information name (e.g., Water Leak), a region 1420 for inputting a configuration information application location (e.g., Home), an action condition configuration region (e.g., first condition information 1431 (e.g., TV, turn on) and a condition add item 1439), and an action add item 1440 for adding an action.

According to various embodiments, when the condition add item 1439 is selected on the action condition configuration region, like screen 1402, the processor 120 of the electronic device 100 may output a condition selection region 1450 for selecting configuration conditions for triggering an action (e.g., a pop-up window including a ‘Time/day(exact)’ item, a ‘Time/day(period)’ item, and a ‘Device condition’ item). When the “Device condition” item corresponding to a device condition is selected, like screen 1403, the processor 120 of the electronic device 100 may output a device list screen (e.g., a screen including a first device item 1451 (e.g., Room A/C), a second device item 1452 (e.g., Philips Hue), a third device item 1453 (e.g., Philips Hue 02), and a fourth device item 1454 (e.g., Multi-purpose sensor)). The device list screen may include information of at least one external device registered with a user account associated with the electronic device 100.

When a user input of selecting the second device item 1452 is received, the processor 120 of the electronic device 100 may provide an action condition configuration screen of the second device item 1452 and may collect action condition configuration depending on a user input. For example, like screen 1405, second condition information 1432 of detecting when an external device (e.g., Philips Hue) is turned on from 10 a.m. to 6 p.m. daily in connection with the second device time 1452 may be added. Thus, the configuration information screen may include first condition information 1431 for verifying a TV turn-on condition and second condition information 1432 for verifying a turn-on condition of a power supply corresponding to the second device item 1452. In addition, according to a user input, an action information item 1441 (e.g., TV, turn on quietly) may be input. The processor 120 may output a device add item 1445 on a display 160 of FIG. 1 to add a device to be operated.

According to various embodiments, the configuration information screen may include a first combination item 1460 (e.g., ‘or’) associated with a combination of the first condition information 1431 and the second condition information 1432. When it is set to the first combination item 1460, a server device 300 with which the configuration information is registered may perform the action information item 1441 depending on each of the first condition information 1431 and the second condition information 1432. For example, when a power supply corresponding to the second device item 1452 is turned on from 10 a.m. to 6 p.m. daily or when a TV device is turned on, the server device 300 may maintain a radio device in a turn-off state.

According to various embodiments, the configuration information screen 1407 may include a second combination item 1470 (e.g., ‘and’) associated with a combination of the first condition information 1431 and the second condition information 1432. According to an embodiment, the second combination item 1470 may be changed in response to a toggle input of the first combination item 1460. On a touch screen where the second combination item 1470 is displayed, when the second combination item 1470 is touched again, the second combination item 1470 may be changed to the first combination item 1460.

When it is set to the second combination item 1470, the server device 300 with which the configuration information is registered may perform the action information item 1441 depending on the first condition information 1431 and the second condition information 1432. For example, when the power supply corresponding to the second device item 1452 is turned on from 10 a.m. to 6 p.m. daily and when the TV device is turned on, the server device 300 may perform an operation associated with turning off a radio device. In this regard, the server device 300 may verify a turn-on state of the power supply and a turn-on state of the TV device at 10 a.m. and may provide action information associated with turning off the radio device to the radio device in response to the verified result.

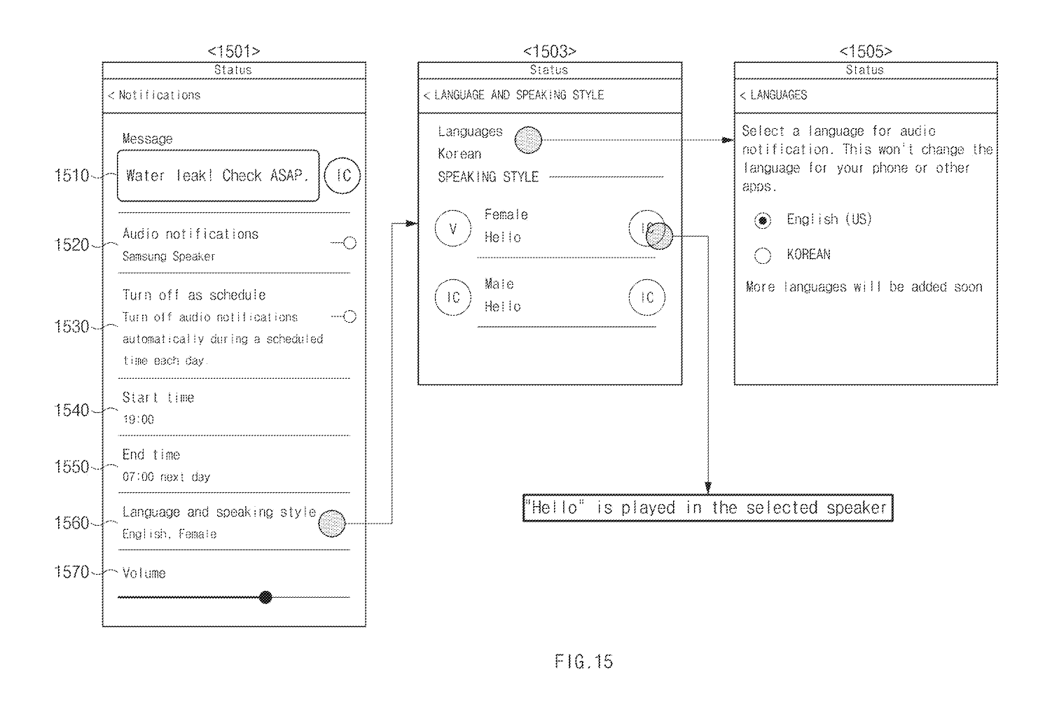

FIG. 15 is a drawing illustrating an example of a screen interface associated with a noti output according to performing an action of an external device, according to an embodiment.

Referring to FIG. 15, when an event or an action associated with at least one external device registered with a user account is generated or performed, a server device 300 of FIG. 1 may transmit notification information (or noti information) according to the generation of the event or the performance of the action to a specified device. In this regard, like screen 1501, an electronic device 100 of FIG. 1 may output a noti configuration screen (or a notification configuration screen) for generating or correcting noti information (or notification information) to be output according to occurrence of a specified event or performance of an action.

On screen 1501, a processor 120 of the electronic device 100 may include a noti configuration screen including a message item 1510, an audio noti item 1520, an audio noti schedule item 1530, a start time item 1540, an end time item 1550, a language selection item 1560, and a volume item 1570. Such a noti configuration screen may be provided by the server device 300 or may be provided according to execution of a specified application installed in the electronic device 100.

The message item 1510 may include an item for configuring notification information which is output in the form of a text. Noti information (or notification information) which is entered in the message item 1510 may be provided to, for example, an external device designated by a user between the electronic device 100 or at least one external device including a display. Receiving the message, each of the electronic device 100 and the external device may output the message on its display.

The audio noti item 1520 may include an item for setting to convert and output a text written in the message item 1510 into a voice. When the audio noti item 1520 is selected, the server device 300 may convert a text written in the message item 1510 into a voice in response to a setting of the audio noti item 1520. Further, the server device 300 may transmit the converted voice to the electronic device 100 or at least one external device including an audio device. In the shown drawing, an embodiment is exemplified as voice information corresponding to the message item 1510 is transmitted to an external audio device registered as a Samsung speaker to be output.

The audio noti schedule item 1530 may include an item for setting such that the audio noti item 1520 is not performed. For example, the audio noti schedule item 1530 may be used to set to perform only a message-based noti function without performing an audio-based noti function during a specified time.

The start time item 1540 may be an item for setting a start time when the audio-based noti function is performed. The end time item 1550 may be an item for setting an end time of the audio-based noti function. The language selection item 1560 may be an item for selecting a language (e.g., Korean, English, Hindustani, or the like) of an audio-based noti or selecting a gender (e.g., a male voice or a female voice) of the audio-based noti. The volume item 1570 may be an item for adjusting a volume level of an audio noti while the audio noti is output.

When the language selection item 1560 is selected, like screen 1503, the processor 120 of the electronic device 100 may output a screen for selecting a type of a language and a gender of the language. In connection with the gender of the language, when a female item is selected, an audio noti may be configured to be output as a female voice. When a male item is selected, the audio noti may be configured to be output as a male voice. When a type region of a language is selected, like screen 1505, the processor 120 of the electronic device 100 may provide a screen for selecting English or Korean.

According to various embodiments, an electronic device may include a communication circuit, a processor, and a memory storing at least one instruction associated with operating the processor, wherein the at least one instruction causes the processor to access a server device based on the communication circuit and a specified user account, receive a device list associated with at least one external device registered based on the user account from the server device, generate configuration information for controlling an action according to a time interval of the at least one external device, based on the device list and a user input, and transmit the configuration information to the server device.

According to various embodiments, the electronic device may further include a display, wherein the at least one instruction causes the processor to output a screen associated with generating the configuration information on the display.

According to various embodiments, the at least one instruction causes the processor to output a screen including at least one of an item for setting a start time and an end time of a specified action of the at least one external device in response to a user input, an item for setting to delay the start time of the specified action of the at least one external device in response to a user input, or an item for setting to delay the end time of the specified action of the at least one external device in response to a user input.

According to various embodiments, the at least one instruction causes the processor to output an external device list selection screen to output notification information indicating an action performance state of the configuration information.

According to various embodiments, wherein the at least one instruction causes the processor to output a noti of at least one of a type of an external device which performs the action among the at least one external device and an action performance state of an external device associated with performing the action.

According to various embodiments, wherein the at least one instruction causes the processor to output a combination item for combining the configuration information, and combine a plurality of configuration information to perform a specific action together as a plurality of external devices included in the external device list meet (or satisfy) a condition or update the plurality of configuration information such that only some of the plurality of external devices perform the action.

According to various embodiments, wherein the at least one instruction causes the processor to output a configuration information screen including at least one of an item for setting at least one situation condition where an action of at least one external device will be executed, in response to a user input, an item for setting at least one time condition where the action of the at least one external device will be executed, or an item for setting a type of at least one action to be executed by the at least one external device.

According to various embodiments, wherein the at least one instruction causes the processor to when an event which occurs in a specified external device is received, output at least one of a text, an image, or an audio indicating the event.

According to various embodiments, wherein the at least one instruction causes the processor to receive a response corresponding to the result of performing an action of a specified external device depending on action information transmitted to the specified external device by the server device, and output at least one of a text, an image, or an audio corresponding to the response.

According to various embodiments, wherein the at least one instruction causes the processor to output a screen including an item for inputting information about another electronic device to share an operation of the configuration information.

According to various embodiments, wherein the at least one instruction causes the processor to output a screen including an item for designating a location of at least one external device to apply the configuration information among the at least one external device.

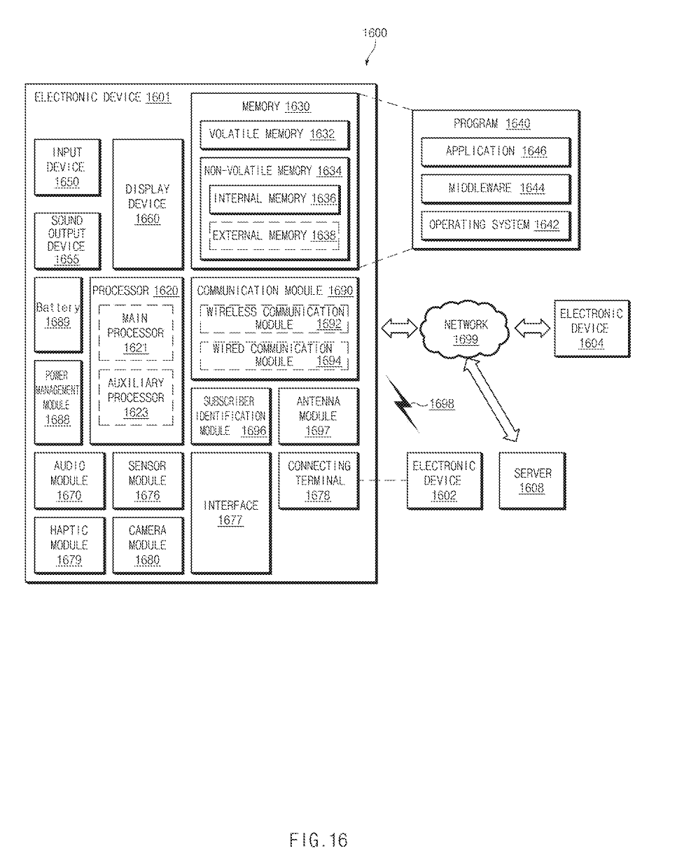

FIG. 16 is a block diagram illustrating an electronic device 1601 in a network environment 1600 according to various embodiments.

Referring to FIG. 16, the electronic device 1601 in the network environment 1600 may communicate with an electronic device 1602 via a first network 1698 (e.g., a short-range wireless communication network), or an electronic device 1604 or a server 1608 via a second network 1699 (e.g., a long-range wireless communication network). According to an embodiment, the electronic device 1601 may communicate with the electronic device 1604 via the server 1608. According to an embodiment, the electronic device 1601 may include a processor 1620, memory 1630, an input device 1650, a sound output device 1655, a display device 1660, an audio module 1670, a sensor module 1676, an interface 1677, a haptic module 1679, a camera module 1680, a power management module 1688, a battery 1689, a communication module 1690, a subscriber identification module (SIM) 1696, or an antenna module 1697. In some embodiments, at least one (e.g., the display device 1660 or the camera module 1680) of the components may be omitted from the electronic device 1601, or one or more other components may be added in the electronic device 1601. In some embodiments, some of the components may be implemented as single integrated circuitry. For example, the sensor module 1676 (e.g., a fingerprint sensor, an iris sensor, or an illuminance sensor) may be implemented as embedded in the display device 1660 (e.g., a display).

The processor 1620 may execute, for example, software (e.g., a program 1640) to control at least one other component (e.g., a hardware or software component) of the electronic device 1601 coupled with the processor 1620, and may perform various data processing or computation. According to one embodiment, as at least part of the data processing or computation, the processor 1620 may load a command or data received from another component (e.g., the sensor module 1676 or the communication module 1690) in volatile memory 1632, process the command or the data stored in the volatile memory 1632, and store resulting data in non-volatile memory 1634. According to an embodiment, the processor 1620 may include a main processor 1621 (e.g., a CPU or an AP), and an auxiliary processor 1623 (e.g., a graphics processing unit (GPU), an image signal processor (ISP), a sensor hub processor, or a CP) that is operable independently from, or in conjunction with, the main processor 1621. Additionally or alternatively, the auxiliary processor 1623 may be adapted to consume less power than the main processor 1621, or to be specific to a specified function. The auxiliary processor 1623 may be implemented as separate from, or as part of the main processor 1621.

The auxiliary processor 1623 may control at least some of functions or states related to at least one component (e.g., the display device 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). According to an embodiment, the auxiliary processor 1623 (e.g., an image signal processor or a communication processor) may be implemented as part of another component (e.g., the camera module 1680 or the communication module 1690) functionally related to the auxiliary processor 1623.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634.

The program 1640 may be stored in the memory 1630 as software, and may include, for example, an OS 1642, middleware 1644, or an application 1646.

The input device 1650 may receive a command or data to be used by another component (e.g., the processor 1620) of the electronic device 1601, from the outside (e.g., a user) of the electronic device 1601. The input device 1650 may include, for example, a microphone, a mouse, or a keyboard.

The sound output device 1655 may output sound signals to the outside of the electronic device 1601. The sound output device 1655 may include, for example, a speaker or a receiver. The speaker may be used for general purposes, such as playing multimedia or playing record, and the receiver may be used for an incoming call. According to an embodiment, the receiver may be implemented as separate from, or as part of the speaker.

The display device 1660 may visually provide information to the outside (e.g., a user) of the electronic device 1601. The display device 1660 may include, for example, a display, a hologram device, or a projector and control circuitry to control a corresponding one of the display, hologram device, and projector. According to an embodiment, the display device 1660 may include touch circuitry adapted to detect a touch, or sensor circuitry (e.g., a pressure sensor) adapted to measure the intensity of force incurred by the touch.

The audio module 1670 may convert a sound into an electrical signal and vice versa. According to an embodiment, the audio module 1670 may obtain the sound via the input device 1650, or output the sound via the sound output device 1655 or a headphone of an external electronic device (e.g., an electronic device 1602) directly (e.g., wiredly) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. According to an embodiment, the sensor module 1676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols to be used for the electronic device 1601 to be coupled with the external electronic device (e.g., the electronic device 1602) directly (e.g., wiredly) or wirelessly. According to an embodiment, the interface 1677 may include, for example, HDMI, a USB interface, a secure digital (SD) card interface, or an audio interface.

A connecting terminal 1678 may include a connector via which the electronic device 1601 may be physically connected with the external electronic device (e.g., the electronic device 1602). According to an embodiment, the connecting terminal 1678 may include, for example, a HDMI connector, a USB connector, a SD card connector, or an audio connector (e.g., a headphone connector).

The haptic module 1679 may convert an electrical signal into a mechanical stimulus (e.g., a vibration or a movement) or electrical stimulus which may be recognized by a user via his tactile sensation or kinesthetic sensation. According to an embodiment, the haptic module 1679 may include, for example, a motor, a piezoelectric element, or an electric stimulator.

The camera module 1680 may capture a still image or moving images. According to an embodiment, the camera module 1680 may include one or more lenses, image sensors, image signal processors, or flashes.

The power management module 1688 may manage power supplied to the electronic device 1601. According to one embodiment, the power management module 1688 may be implemented as at least part of, for example, a power management integrated circuit (PMIC).

The battery 1689 may supply power to at least one component of the electronic device 1601. According to an embodiment, the battery 1689 may include, for example, a primary cell which is not rechargeable, a secondary cell which is rechargeable, or a fuel cell.

The communication module 1690 may support establishing a direct (e.g., wired) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., AP) and supports a direct (e.g., wired) communication or a wireless communication. According to an embodiment, the communication module 1690 may include a wireless communication module 1692 (e.g., a cellular communication module, a short-range wireless communication module, or a global navigation satellite system (GNSS) communication module) or a wired communication module 1694 (e.g., a LAN communication module or a power line communication (PLC) module). A corresponding one of these communication modules may communicate with the external electronic device via the first network 1698 (e.g., a short-range communication network, such as Bluetooth™, Wi-Fi direct, or infrared data association (IrDA)) or the second network 1699 (e.g., a long-range communication network, such as a cellular network, the Internet, or a computer network (e.g., LAN or WAN). These various types of communication modules may be implemented as a single component (e.g., a single chip), or may be implemented as multi components (e.g., multi chips) separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

The antenna module 1697 may transmit or receive a signal or power to or from the outside (e.g., the external electronic device) of the electronic device 1601. According to an embodiment, the antenna module 1697 may include one or more antennas, and, therefrom, at least one antenna appropriate for a communication scheme used in the communication network, such as the first network 1698 or the second network 1699, may be selected, for example, by the communication module 1690 (e.g., the wireless communication module 1692). The signal or the power may then be transmitted or received between the communication module 1690 and the external electronic device via the selected at least one antenna.

At least some of the above-described components may be coupled mutually and communicate signals (e.g., commands or data) there between via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1601 and the external electronic device 1604 via the server 1608 coupled with the second network 1699. Each of the electronic devices 1602 and 1604 may be a device of a same type as, or a different type, from the electronic device 1601. According to an embodiment, all or some of operations to be executed at the electronic device 1601 may be executed at one or more of the external electronic devices 1602, 1604, or 1608. For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1601. The electronic device 1601 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1640) including one or more instructions that are stored in a storage medium (e.g., internal memory 1636 or external memory 1638) that is readable by a machine (e.g., the electronic device 1601). For example, a processor (e.g., the processor 1620) of the machine (e.g., the electronic device 1601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A server comprising:
at least one communication circuit;
at least one memory storing at least one instruction and configuration information associated with a user account, the configuration information including a trigger condition of a first action, a delay time of the first action, and a duration of the first action; and
at least one processor operatively connected with the at least one communication circuit and the at least one memory,
wherein the at least one processor, when executing the at least one instruction, is configured to:
control to receive an event from a first external device associated with the user account through the at least one communication circuit;
when the received event meets the trigger condition of the first action, control to transmit first action information to start the first action to a second external device associated with the user account after the delay time of the first action elapses; and
control to transmit, through the at least one communication circuit, second action information to end the first action to the second external device after the duration of the first action, from the time when the first action information is transmitted, elapses.

2. The server of claim 1, wherein the at least one processor, when executing the at least one instruction, is configured to:
control to receive the configuration information from a mobile device associated with the user account.

3. The server of claim 2, wherein the at least one processor, when executing the at least one instruction, is configured to:
control to receive, from the second external device, a first response indicating that the first action is started in the second external device; and
control to transmit a first notification associated with the first response to the mobile device.

4. The server of claim 1, wherein the at least one processor, when executing the at least one instruction, is configured to:
control to receive, from the second external device, a second response indicating that the first action is started in the second external device; and
control to transmit a second notification associated with the second response to the mobile device.

5. The server of claim 1, wherein the at least one processor, when executing the at least one instruction, is configured to:
control to perform an action of at least one of the first external device and the second external device,
wherein the first external device and the second external device are fixed devices.

6. The server of claim 1, wherein the at least one processor, when executing the at least one instruction, configured to:
control to communicate with a mobile device over a cellular network to receive the configuration information; and
control communicate with the first external device and the second external device over an Internet of things (IoT) network to transmit the first action information or the second action information,
wherein the IoT network has less bandwidth than the cellular network.

7. An electronic device comprising:
at least one communication circuit;
at least one memory storing at least one instruction; and
at least one processor operatively connected with the at least one communication circuit and the at least one memory,
wherein the at least one processor, when executing the at least one instruction, is configured to:
control to access a server device based on the communication circuit and a specified user account;
control to receive a device list associated with at least one external device registered based on the user account from the server device;
generate configuration information for controlling an action according to a time interval of the at least one external device, based on the device list and a user input; and
control to transmit the configuration information to the server device.

8. The electronic device of claim 7, further comprising:
a display,
wherein the at least one processor, when executing the at least one instruction, is configured to control to output on the display a screen associated with generating the configuration information.

9. The electronic device of claim 8, wherein the at least one processor, when executing the at least one instruction, is configured to control to output on the display a screen including at least one of:
an item for setting a start time and an end time of a specified action of the at least one external device in response to a user input,
an item for setting to delay the start time of the specified action of the at least one external device in response to a user input, or
an item for setting to delay the end time of the specified action of the at least one external device in response to a user input.

10. The electronic device of claim 8, wherein the at least one processor, when executing the at least one instruction, is configured to control to output on the display an external device list selection screen to output notification information indicating an action performance state of the configuration information.

11. The electronic device of claim 8, wherein the at least one processor, when executing the at least one instruction, is configured to control to output on the display a notification of at least one of a type of an external device which performs the action among the at least one external device or an action performance state of an external device associated with performing the action.

12. The electronic device of claim 10, wherein the at least one processor, when executing the at least one instruction, is configured to:
control to output on the display a combination item for combining the configuration information; and
combine a plurality of configuration information to perform a specific action together as a plurality of external devices included in the external device list meets a condition or update the plurality of configuration information such that only some of the plurality of external devices perform the action.

13. The electronic device of claim 8, wherein the at least one processor, when executing the at least one instruction, is configured to control to output on the on the display a configuration information screen including at least one of:
an item for setting at least one situation condition where an action of at least one external device will be executed, in response to a user input,
an item for setting at least one time condition where the action of the at least one external device will be executed, or
an item for setting a type of at least one action to be executed by the at least one external device.

14. The electronic device of claim 7, wherein the at least one processor, when executing the at least one instruction, is configured to when an event which occurs in a specified external device is received, control to output at least one of a text, an image, or an audio indicating the event.

15. The electronic device of claim 7, wherein the at least one processor, when executing the at least one instruction, is configured to:
control to receive a response corresponding to a result of performing an action of a specified external device depending on action information transmitted to the specified external device by the server device; and
control to output at least one of a text, an image, or an audio corresponding to the response.

16. The electronic device of claim 7, wherein the at least one processor, when executing the at least one instruction, is configured to control to output a screen including an item for inputting information about another electronic device to share an operation of the configuration information.

17. The electronic device of claim 7, wherein the at least one processor, when executing the at least one instruction, is configured, to control to output a screen including an item for designating a location of at least one external device to apply the configuration information among the at least one external device.

18. A method of an electronic device comprising:
accessing a server device based on a specified user account;
receiving a device list associated with at least one external device registered based on the user account from the server device;
generating configuration information for controlling an action according to a time interval of the at least one external device, based on the device list and a user input; and
transmitting the configuration information to the server device.

19. The method of claim 18, further comprising:
outputting on a display of the electronic device a screen associated with generating the configuration information.

20. The method of claim 19, further comprising:
outputting on the display a screen including at least one of:
an item for setting a start time and an end time of a specified action of the at least one external device in response to a user input,
an item for setting to delay the start time of the specified action of the at least one external device in response to a user input, or
an item for setting to delay the end time of the specified action of the at least one external device in response to a user input.
